(19) United States
(12) Patent Application Publication
(10) Pub. No.: US 2019/0288640 A1
(43) Pub. Date: Sep. 19, 2019

(54) SOLAR RECEIVER AND PROCESS

(71) Applicant: Donald Bennett Hilliard, Tucson, AZ (US)

(72) Inventor: Donald Bennett Hilliard, Tucson, AZ (US)

(21) Appl. No.: 16/365,430

(22) Filed: Mar. 26, 2019

Related U.S. Application Data
(63) Continuation of application No. 15/338,392, filed on Oct. 30, 2016, now abandoned.
Application No. 15/338,392 is a division of application No. 13/261,526, filed on Jan. 2, 2014, now abandoned.
(60) Provisional application No. 61/455,576, filed on Oct. 23, 2010.
(60) Provisional application No. 61/397,275, filed on Jun. 8, 2010.
(60) Provisional application No. 61/396,387, filed on May 26, 2010.

(51) Int. Cl. H02S 40/22; F24S 20/20; F24S 23/75; H02S 40/44

(52) U.S. Cl. CPC H02S 40/22; F24S 20/20; F24S 23/75; Y02E 10/41; Y02E 10/52; Y02E 10/60; H02S 40/44

(57) ABSTRACT

The invention relates to apparatus utilized for concentrating and converting solar energy. In a first preferred embodiment, the disclosed solar concentrator is utilized in conjunction with a solar-energy conversion device located within the volume of the concentrator, and, in the first preferred embodiment, is a solar-thermal receiver module utilizing absorbing media wherein absorption occurs both in a liquid media and by means of a photovoltaic array.

### TECHNICAL FIELD

The present application is a continuation of U.S. patent application Ser. No. 15/338,392, filed Oct. 30, 2016 (Hilliard), which was a divisional application of U.S. patent application Ser. No. 13/261,526 (Hilliard), which is the national stage application of international application PCT/US2011/00966 (Hilliard), filed May 26, 2011, which international application claims the benefit of three U.S. provisional patent applications; namely, U.S. Provisional Patent Application No. 61/396,387 (Hilliard), filed on May 26, 2010, U.S. Provisional Patent Application No. 61/397,275 (Hilliard), filed on Jun. 8, 2010, and, U.S. Provisional Patent Application No. 61/455,576 (Hilliard), filed on Oct. 23, 2010, all of which foregoing applications are, in their entirety, incorporated herein by reference. The present invention relates to process and apparatus in field of concentrated solar power and associated solar energy conversion apparatus; and, more particularly, in solar receiver tubes, concentration optics, and their operation.

### BACKGROUND ART

A primary obstacle in the commercialization of solar energy conversion devices, whether with regards to solar-thermal, solar photovoltaic's, concentrated solar systems, etc, comprises the need to simultaneously minimize manufacturing costs while maintaining physical tolerances and durability necessary to retain a desired efficiency and device lifetime. In segments of the solar energy industry utilizing a solar concentrator or condenser, the challenge to reduce manufacturing costs is most significant in the solar collector design, as the component generally requiring the greatest materials expense. A crowded array of art has been introduced to address this challenge, including, broadly speaking, such relatively large solar concentrators as linear trough systems and linear Fresnel systems, dish systems including parabolic and compound reflectors. Also, various, typically in conjunction with photovoltaics, concentrators have been utilized in solar panels that incorporate a periodic array of concentrators that couple to a receiver. Within these broad groups of concentrating means are utilized a vast assortment of optical designs that, while utilizing well-known refractive, diffractive, and reflective properties of well-known and understood optical components, are primarily advanced on the basis of a particularly advantageous manufacturing approach involving a proprietary geometric optics design, which in turn is expected to deliver a desirable cost per kilowatt delivered.

A problem with these various solar concentrators of the prior art is their reliance on proprietary system components that require widespread adoption of a narrowly applicable optical system as a precondition to a projected cost performance. In addition, these system components are typically plagued by materials development issues that are unique to the particular system in question and its operational characteristics. These system-specific materials challenges result in circumstances wherein expending resources on materials development will be compensated only if the specific solar application addressed is successfully commercialized, thus increasing investment risks.

There is therefore a need in the solar industry for a solar concentrator that provides, relatively to previous designs, much higher strength-to-weight ratio and rigidity-to-weight ratio, this with a commensurate savings in manufacturing cost, and while providing an inherently high-precision tooling and manufacturing platform; in addition, it is more preferable that this solution be in a concentrator format that enables utilization broadly across numerous segments of the concentrating solar industry, so that such a concentrator is readily adaptable to both a wide range of concentration ratios and solar energy-conversion processes.

### DISCLOSURE OF INVENTION

In accordance with the first preferred embodiments, a compound conical concentrator comprising a solar concentrating reflector is disclosed. In a first embodiment, a high-reflectivity (>90% reflectivity in visible spectrum) conical frustum is disclosed, comprising a conical frustum structure comprising a double-layered structure wherein parallel outer layers are separated by an integral, lightweight, networked structure comprising the mesh structure of a hollow core, preferably comprising a honeycomb-type core. In a major sectional profile taken through a plane containing the frustum's central axis, the frustum has opposite parallel surfaces in the form of a parallelogram; the double-layer structure comprising opposing inner and outer surfaces of the conic frustum, the first surface and second surface roughly parallel the inner surface preferably having an optical reflectivity of at least 90%, preferably with a divergence of inner surface of less than 1% from the associated, theoretically ideal frustum surface.

The inner core of the embodied frustum preferably comprises a plurality of concentric and parallel ring-shaped surfaces extending between inner frustum surface and outer frustum surface, the ring-shaped surfaces at a substantially uniform acute angle adjoining inner and outer frustum surfaces, wherein separated rings of the honey comb material are preferably sandwiched within the spaces formed between these concentric rings and between the inner and outer surfaces of the embodied frustum. The core mesh material is preferably an expanded core material between first and second surfaces, the expanded core material having a regular pattern of structural walls forming a regular pattern of open spaces, the walls roughly orthogonal to the ring-shaped surfaces, and in the preferred mode comprising an aluminum honeycomb structure. In addition, the preferred sectional profile of a parallelogram is provided by, in addition to parallel inner and outer surfaces of the frustum, parallel top and bottom edge-surfaces of the embodied frustum, which are accordingly parallel to one another, and more preferably have an orthogonal relationship with surfaces of the inner core materials comprising mesh core material and ring-shaped surfaces. The parallel top and bottom edge-surfaces of the embodied frustum are accordingly, preferably, orthogonal to the optical axis of the conic frustum, or alternatively such edge-surfaces are parallel to the frustum's optical axis and accordingly comprise cylindrical surfaces; in either case, such top and bottom edge-surfaces provide the preferred orthogonal relationship to surfaces of the inner core materials, with the preferred sectional profile of a parallelogram. The top and bottom, and preferably parallel edge-surfaces of the embodied stackable conic frustums comprise alignment surfaces for aligning and stacking a series of adjacent frustums in a coaxial arrangement.

Further embodied is a stackable conic frustum comprising a single conical section constructed of a single self-standing integral structure having substantially parallel inner and outer surfaces, the frustum comprising a composite layer of approximately uniform thickness, the frustum having an inner surface and outer surface comprised of a flexible sheet metal, the frustum having an inner core comprising a first multitude of first supporting members comprising a thin sheet material, the inner core comprising a multitude of second supporting members comprising a thin sheet material, the first supporting members having a roughly perpendicular relation to the second supporting members as determined in a sectional plane containing the optical axis of the frustum, wherein both first members and second members adjoin the flexible sheet metal so that the inner surface, first members, and second members are coordinated in a triangular formation.

Wherein the frustum is a network of interlocking tetrahedral structures, the tetrahedral structures characterized by continuous lengths of structural material—whether inner frustum surface layer, outer frustum surface layer, concentric ring-shaped surfaces, or mesh core material—interlinking vertices of the tetrahedral structures.

Thus an objective of the present invention is to provide a conical frustum incorporating tetrahedral reinforcement structures within the interior of each frustum, providing rigidity-enhancing tetrahedral structures formed at interfaces between embodied frustum surface cladding and the interior core structure of the frustum. The embodied interlocking tetrahedral reinforcing structure of the inventive conic frustums is advantageous over conventional honeycomb panels, since the tetrahedral space-frame geometry of the embodied frustums offers the highest intrinsic strength and rigidity for given mass over either prior art honeycomb panels or a square-pyramid space-frame, thus lowering potential of interfacial shear stress at the interface between core materials and the inner and outer surface cladding—or “skin”—of the embodied hollow-core frustum structure.

An objective of the presently embodied solar concentrating reflector is accordingly to provide an assembly of conical frustums that each have a sectional profile, as taken through a sectioning plane that contains the frustum's optical axis, which comprises a parallelogram, and wherein external surface of such a frustum accordingly comprise parallel inner and outer frustum surfaces as well as two parallel edge-surfaces, wherein edge surfaces are surface adjoining the inner and outer surfaces of the frustum at its top and bottom.

In a further embodiment, there is disclosed in the present invention a stacked compound conical concentrator (CCC) comprising a compressively loaded stack of coaxial frustum structures, the frustum structures each comprising a double-walled, hollow-core reinforced structure with reflective inner surface layer and having interior-core support members at acute angles to the reflector layer, the stack of frustum structures preferably compressed along its central optical axis by means of a plurality of flexible straps fastened at opposite ends to top and bottom regions of the frustum-stack comprising the CCC. The flexible straps are preferably maintained in a stretched condition (i.e, under tensile loading that is substantially equivalent to the preferred compressive loading of the stack) by means of an intermediate spacing/tensioning ring located substantially concentric to the optical axis and intermediate to upper and lower fastening means located at accordingly the top and bottom of the embodied CCC.

A telescoping CCC is further embodied that is disposed for rapid deployment and stowage, wherein a series of interlocking frustums is stowed in a contracted form that is preferably extended to its operating state by pulling a base section along the optical axis, whereby interlocking surfaces of the adjacent frustums are brought into a interfacing orientation, the frustums preferably prevented from over-extension by stopping surfaces, and registered to desired position by a plurality of retractable interlocking mechanisms. Self-alignment of the CCC structure is accomplished in relatively expedient manner by subsequently compressing the telescoping structure in its extended and interlocked position by means of a plurality of the tensioned straps (including cords, wires, cables, ropes, etc) that are evenly spaced for uniformly compressing the CCC along its optical axis, so that preferably the uniform and axial compressive force can cause deformation of the CCC only in accordance with a uniform axially directed force.

It is accordingly preferred, in the telescoping embodiments, that the individual conical frustums of the present invention are constructed so that upper and lower edge-surfaces of the frustum structures are terminated as a cylindrical surfaces having central axis coincident with the optical axis, so the reflective, inwardly facing frustum surface and outer-facing frustum surface are interconnected and terminated at both upper edge-surface and lower edge-surface by these adjoining cylindrical surfaces.

A method for making a clad conical frustum, comprising the steps of:

forming a preform structure, the preform structure comprising a multilayer stack of repeating layers, the layers alternating between layers of a substantially continuous sheet metal and layers comprising and an expanded metal core material; machining the structure to form a first parted surface of the preform, the first parted surface conical; laminating a reflective material layer to the first parted surface of the preform, the reflective material layer having a first reflective-layer side and a second reflective-layer side, the first reflective-layer side terminated with a high-reflectivity coating, the second reflective-layer side laminated to the first parted surface of the preform to form a supported reflective surface; performing a parting operation wherein the preform is parted so as to separate a conical frustum structure from the preform, the conical frustum having an inner conical surface formed by the reflective material, the conical frustum having a second parted side formed by the parting operation; and, laminating an outer frustum layer to the outer parted surface of the parted frustum structure to form the clad conical frustum, the clad frustum having an outer conical surface formed by the outer frustum layer, so that the clad frustum comprises a self-standing structure of substantially uniform thickness.

Preferably, the reflective material is laminated to the first parted frustum surface (a discontinuous surface) while this surface is still integral to the preform and provided its desired figure by finishing means. Lamination of the reflector material to the first parted surface then provides added rigidity to the immediately underlying preform structure, so that subsequent cutting of the second parted surface of the instant frustum, whereby the frustum is separated from the preform, may be conducted without undesired strain of the frustum structure.

In its first preferred embodiment, the disclosed concentrator is utilized for providing high-concentration (e.g., 500× for irradiation of high-temperature solar-thermal receiver tubes, particularly those disclosed in the listed earlier co-pending applications by same author. In a further embodiment, associated solar energy conversion apparatus are disclosed that are seen as uniquely advantageous when utilized in combination with the disclosed CCC. Particularly, in an alternative preferred embodiment, a photovoltaic (PV) module comprising multiple multijunction photovoltaic (MJPV) arrays arranged on a faceted cylinder comprising bus leads and conductive cooling means. The embodied MJPV module is incorporated into the embodied tubulated hot-finger for irradiation by the CCC for combined heat and electrical power generation (CHP), wherein efficient cooling of the MJPV is performed by incorporation of an internal coaxial cooling conduit for cooling the MJPV module by oil or alternatively water, or a mixture thereof.

In a further preferred embodiment, the return path for the heat transfer fluid (HTF) of the present MJPV-CHP embodiment, comprises a substantially transparent return passage that comprises an annular passage-way surrounding the MJPV module, so that an HTF that is substantially transparent to solar radiation passes in front of the MJPV arrays (e.g., Ge/GaInP/GaAs), the HTF thereby being additionally heated by the concentrated solar radiation of the CCC. This present alternative MJPV-CHP embodiment is particularly advantageous for providing an HTF at considerably higher temperatures than the preferred operating temperature of the MJPV module (<100 C). The embodied HTF in the annular transparent passage is further advantageous in its ability to be tailored to a specific absorption spectrum, so that, for example, IR radiation that is in excess of that to required for current-balancing of the MJPV array is absorbed by the HTF, rather than being absorbed by the MJPV so as to result in undesirable heating of the MJPV array. In this manner, the present alternative MJPV-CHP embodiment utilizing HTF-shielding of the MJPV array in conjunction with the preferred CCC, can be readily deployed utilizing an over-powered CCC (e.g., 700× suns), wherein the HTF can be tailored to optimize the spectral characteristics of the light that is actually incident upon the MJPV array.

The HTF-shielded MJPV/CHP allows for band-gap engineering of the MJPV module to be optimized for manufacturability rather than to precisely accommodate a specific soar spectrum (e.g., ASM 1.5D). This is seen as a further great advantage, since much of the cost of optimum MJPV modules is incurred by the introduction of lattice-matching layers, buffer layers, and nucleation layers that enable utilization of semiconductor materials that are optimum for a segment of the solar spectrum, but are not particularly compatible in a heteroepitaxial arrangement. Not only do these according heteroepitaxial MJPV structures incur additional manufacturing expenses in fabrication, there is also great expense incurred in losses due to higher defect levels resulting from lattice mismatch, and the consequent binning process whereby the lifetime and power rating of the MJPV module is determined. In the present embodiments, utilizing HTF-shielding, MJPV designers are provided a degree of freedom in that MJPV arrays may be manufactured with spectral characteristics optimized for more ideal lattice matching and robust MJPV processing, rather than a specific solar spectrum, Instead the MJPV can be designed and manufactured to optimize a particular spectrum resulting from filtration of the solar spectrum by both the earth's atmosphere and the optimized HTF's spectral absorption, wherein the HTF's spectral absorption is, in turn, optimized for cost-effective manufacturing of the MJPV; in particular, by providing greatest transmission in the vicinity of each semiconductor material's band-edge, as well as by allowing relatively high optical transmission for spectral requirements of the MJPV junction that is most limiting to overall current through the MJPV (with junctions connected in series). In addition, an HTF's spectral absorption, in the present alternative embodiment, can be altered in real time to adjust to daily and seasonal changes, so that an algorithm-driven circulation system may remove or introduce a particular absorber (e.g., water) into the HTF fluid (e.g., ethylene glycol) so as to optimize the MJPV performance in relation to the solar spectrum available, as a function of time-of-day and seasonal changes, at the particular site where such a MJPV-CHP system is deployed. With the cost-effective CCC embodiments of the present invention, and utilization of the heated HTF for use in various solar-thermal applications of the prior art, it is therefore not necessary to maximize utilization of every particular wavelength of the available solar spectrum for promoting electricity generation in the MJPV, since the MJPV may instead be irradiated to its optimum power rating by the HTF-filtered spectrum using an over-concentrating CCC (e.g., 700× suns), whereas almost all other available solar energy is converted to usable solar-thermal energy in the HTF.

In another embodiment, the embodied CCC is utilized in conjunction with hydrogen generation means particularly embodied for utilization with solid oxide fuel cell and associated hydrogen generating means. In particular, hydrogen-bearing gases are reformed by means of annular solid oxide-based apparatus operated in hydrogen generation mode, wherein an integral storage tank is also embodied for storage of an energy storage medium.

Another advantage of the present invention is realization of rigid freestanding conical frustums that may be stacked and loaded mechanically with compressive force in the direction of the optical axis of the stacked frustums.

A primary advantage of the concentrator design herein is in its ability to allow precision optical resolution and concentration factors equivalent to parabolic dish systems, without the expenses associated with making actual aspherical surfaces. The parabolic and other aspheric concentrators of the prior art that require quadratically derived surfaces, or surfaces that possess curvatures in more than one axis, typically require both proprietary molding/shaping processes for producing panels that possess these aspheric properties. Instead, the present embodiments realize the concentration capabilities of a tracking parabolic dish, but through use of flat reflector sheet utilized for less concentration trough systems. Rather than incorporating the relatively expensive forming of quadratic surfaces that is required in prior art trough systems and tracking parabolic dishes, the present embodiments provide high concentration by use of linear structural elements

Another important advantage of the present invention is its use of reflector materials that may be produced by roll-to-roll manufacturing; that is, sheet material that is manufactured in a substantially planar form that can be processed and stored using rolls of sheet material, and through use of such manufacturing processes as roller mills and web processing. In the preferred embodiments, the reflector material is fashioned into segments that are each provided a shape unique for the purpose of matching the surface area and shape of a conic frustum incorporated in the CCC structure.

Another advantage of the presently embodied solar concentrating reflector is in the realization of a telescoping compound conical concentrator which replaceable conic frustums.

Another advantage of the presently embodied solar concentrating reflector is in the realization of an expandable compound conical concentrator that can be deployed rapidly in remote locations or for distributed generation.

Another advantage of the presently embodied solar concentrating reflector is in the realization of an expandable compound conical concentrator that is transported in a contracted form within a container that is smaller in depth than the assemble CCC, and preferably less than twice the depth of the deepest frustum in the container.

Another advantage of the presently embodied solar concentrating reflector is in the realization of an expandable compound conical concentrator wherein component frustums for greater that 20, and preferably greater than 50 CCC's are shippable in a container of volume equal or less in height than twice the height of one of the same CCC in its assembled operational form.

Another advantage of the presently embodied solar concentrating reflector is in the realization of an expandable compound conical concentrator that is simultaneously adaptable for CHP utilizing multijunction PV, solar thermal for molten salts, or fuel cell hydrogen production. WEAK

Another advantage of the presently embodied solar concentrating reflector is in the realization of an expandable compound conical concentrator that is transported

Other objects, advantages and novel features of the invention will become apparent from the following description thereof.

A primary advantage of the concentrator design herein is in its ability to allow precision optical resolution and concentration factors equivalent to parabolic dish systems, without the expenses associated with making actual aspherical surfaces

### BRIEF DESCRIPTION OF DRAWINGS

FIG. 1 is a diagram of a single-ended, tubulated solar receiver of the preferred embodiments, integrated with a compound conical concentrator of the preferred embodiments, comprising a N=6 concentrator.

FIG. 2 is a front sectional cut-out view of a solar tracking apparatus utilizing a compound conical concentrator and receiver tube in a preferred embodiment, wherein section is taken along the normal plane containing pivot axis (62), and wherein the receiver tube is aligned to the pivot axis.

FIG. 3 is a top view of flat reflective sheet segments for a CCC of the preferred embodiments.

FIG. 4 (a) is a perspective view of a single-ended and tubulated receiver tube of the preferred embodiments comprising a dual-use solar thermal receiver and multi junction PV collector. FIG. 4(b) is an aluminum honeycomb panel of the prior art.

FIG. 5(a-d) is preform providing parted frustum structures of the present invention, comprising (a) sectional side-view of a planar, honeycomb-reinforced, sheet having mid-plane (151), (b), a close-up caption (150) comprising a sectional top-view of the sheet taken along plane (151), (c), a sectional side-view of a toroidal preform of the preferred embodiments, with sectioning plane taken through central axis (73) and, (d) a sectional side-view of the annulus comprising the toroidal preform.

FIG. 6(a-c) is a self-supported frustum of the preferred embodiments comprising (a) a side-sectional view of the annular structure forming the frustum, (b) a side sectional view of an alternative preferred embodiment of the annular structure forming the frustum, and (c) a perspective view of the self-supported frustum in accordance with the preferred embodiments.

FIG. 7 is a side-sectional schematic view of a hot-finger/CCC assembly of the invention, comprising an, N=11, CCC structure and alternative preferred embodiments of a hotfinger assembly of the invention with a cylindrical region of highest optical flux.

FIG. 8(a-d) are schematics of internal structure of a conical frustum in accordance with the preferred embodiments comprising, (a) relative orientation of consecutive expanded core material, (b) a tetrahedral coordination diagram, (c) a side-sectional schematic of a truss structure, and (d) a perspective cut-away of a conical frustum in accordance with the preferred embodiments, with cutaway section taken through plane, a′, the plane containing optical axis (73).

FIG. 9 (a-b) is a side-section view of a preferred interlocking mechanism comprising (a) edge-surface regions of adjoining conical frustums in accordance with the preferred embodiments, and (b) a side section view of interlocking frustums of the preferred embodiments.

FIG. 10(a-b) are perspective views of an assembled CCC in accordance with the preferred embodiments.

FIG. 11 (a-b) is a side sectional view of an assembled CCC of the preferred embodiments comprising (a) a side sectional view of the embodied CCC in a contracted form, and, (b) a side sectional view of the embodied CCC in an extended and assembled form, with sectioning plane taken through central optical axis (73).

FIG. 12(a-b) is a preform structure in accordance with an alternative preferred embodiment, comprising (a) side section view, and (b) a perspective, cut-away, sectional view with cut-away region (140) revealing interior honeycomb core layers.

FIG. 13(a-b) comprises (a) a side sectional view of a shipping container housing component frustums of a multitude of CCC's of the preferred embodiment, and, (a) spectral characteristic of a terrestrial solar irradiance with MJPV and HTF absorption characteristics in accordance with an alternative embodiment of a MJPV/CHP receiver tube.

FIG. 14(a-c) is an alternative preferred embodiment comprising (a) side-sectional view taken though a plane containing central axis (9) of a MJPV/CHP receiver tube, (b) is a sectional end-view orthogonal to central axis (9) of the MJPV/CHP receiver tube, and (c) is an inner transparent receiver tube with patterned absorber coating.

FIG. 15 is a multi junction PV solar receiver of the preferred embodiments.

FIG. 16(a-b) is a (a) side-sectional and (b) front view of a single-ended, tubulated solar receiver of the preferred embodiments, wherein side-sectional view 6(a) is taken through plane (6) in front-view of 7(b).

FIG. 17(a-b) is a tubulated solar receiver and integrated 2-axis rotating union in accordance with a preferred embodiment, comprising a (a) front-sectional and (b) front view, wherein section is taken through central axis (9) of receiver tube and normal to plane (6) in FIG. 16.

FIG. 18 is a foreshortened side sectional view of a CCC of the preferred embodiments in conjunction with a photo-catalytic hydrogen generation device and an annular SOFC.

### BEST MODE FOR CARRYING OUT THE INVENTION

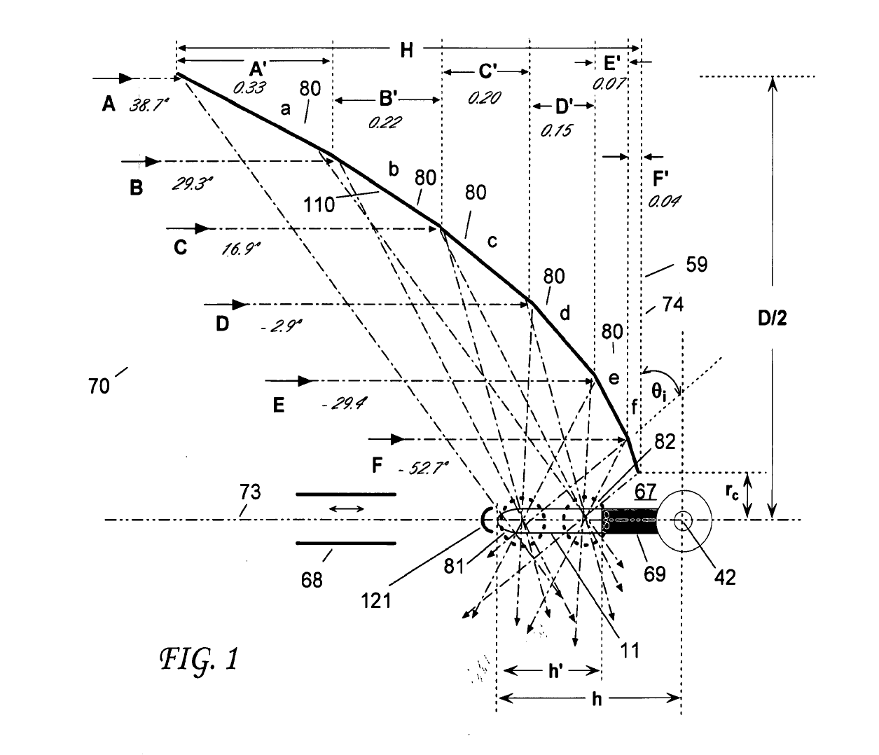

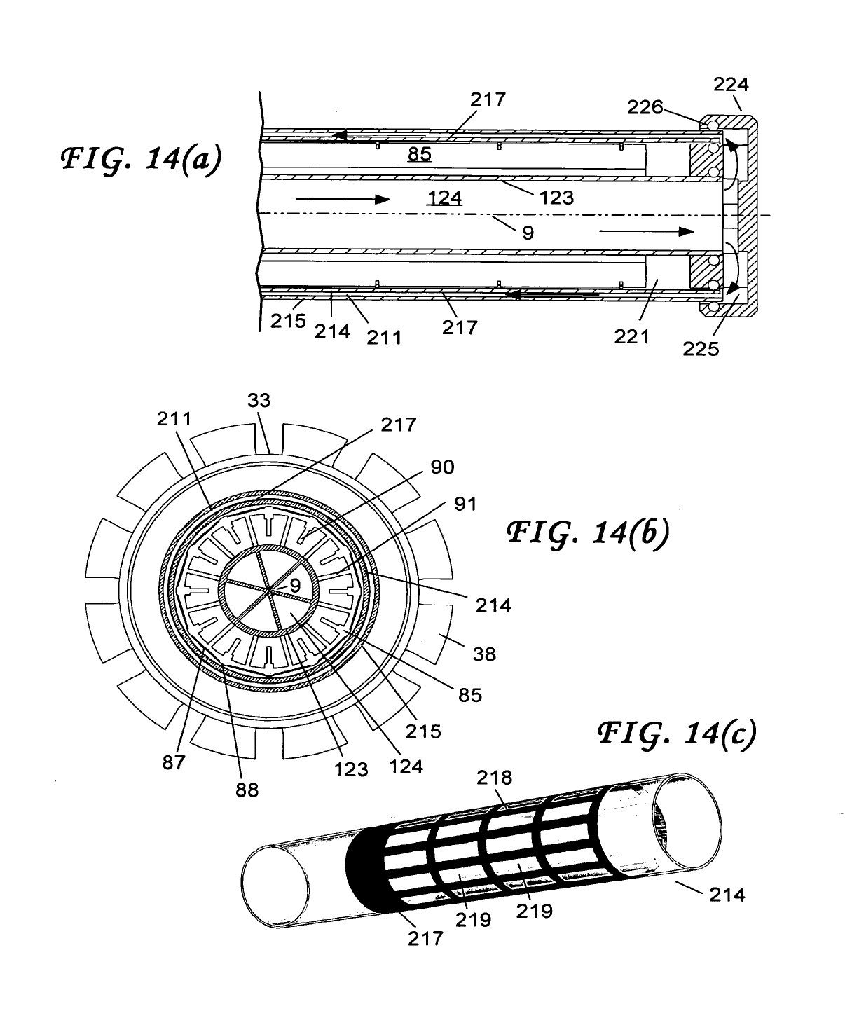

In accordance with the preferred embodiments, a solar concentrator system comprising multiple conical frustums, with associated energy-conversion apparatus, is disclosed in conjunction with FIGS. 1-18 and in conjunction with the relied-upon co-pending applications of the present disclosure, which are included herein, in their entirety, by reference. While the embodied CCC structure may be realized in a wide variety of concentrators that embody its primary structural elements, it is found in the present invention that certain preferred features and manufacturing methods are preferred for low-cost manufacture and efficient energy conversion.

Accordingly, a CCC of the present invention comprises at least five conical reflector sections (80) comprising a conical frustum. In the preferred embodiments, it may thus be readily understood that each conical section, or frustum, will concentrate direct solar radiation into an identical volume comprising the embodied receiver tube. Accordingly, a region of upper foci (81) determined by optical rays propagating from an uppermost reflective region of each reflecting frustum is located near the top portion, preferably closed end, of the absorbing receiver tube. Conversely, a region of lower foci (82) resulting from optical rays propagating from bottom reflective region of each reflecting frustum, will reside in a bottom portion of the receiver tube. Herein, “bottom” of the conical sections refers to the smaller end of the conical frustum that is closest to the tilt axis.

The CCC height H is defined by the total height of reflective area of the main conical sections. The length h of the receiver tube assembly from its top to the tilt axis (42) is preferably provided such that the clearance distance between CCC base plane (59) and tilt axis (42) is greater than 20 cm, and more preferably greater than 50 cm. The distance between platform and tilt axis may be provided with any reasonable dimension providing the needed clearance between CCC structure and platform. Alternatively, clearance for the CCC structure at low altitude (morning and late afternoon) tilt settings be provided in part by placement of the platform on an elevated structure, such as a structure housing the intended work load.

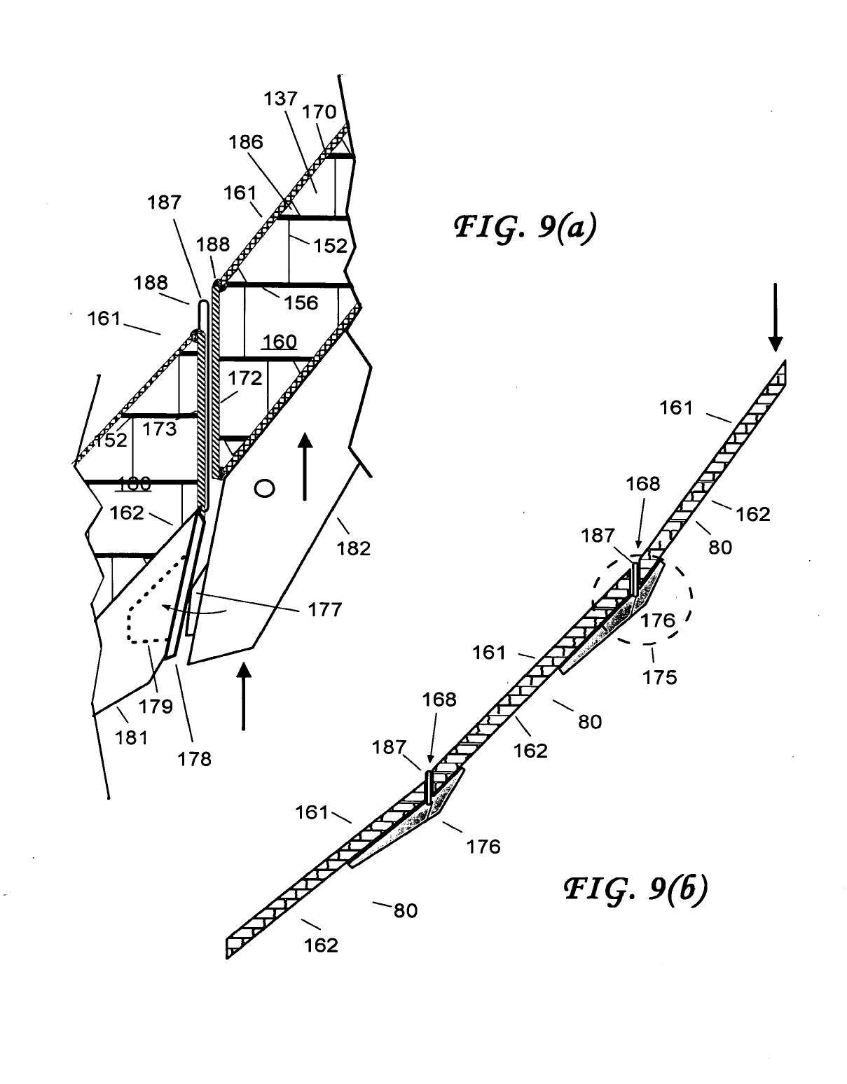

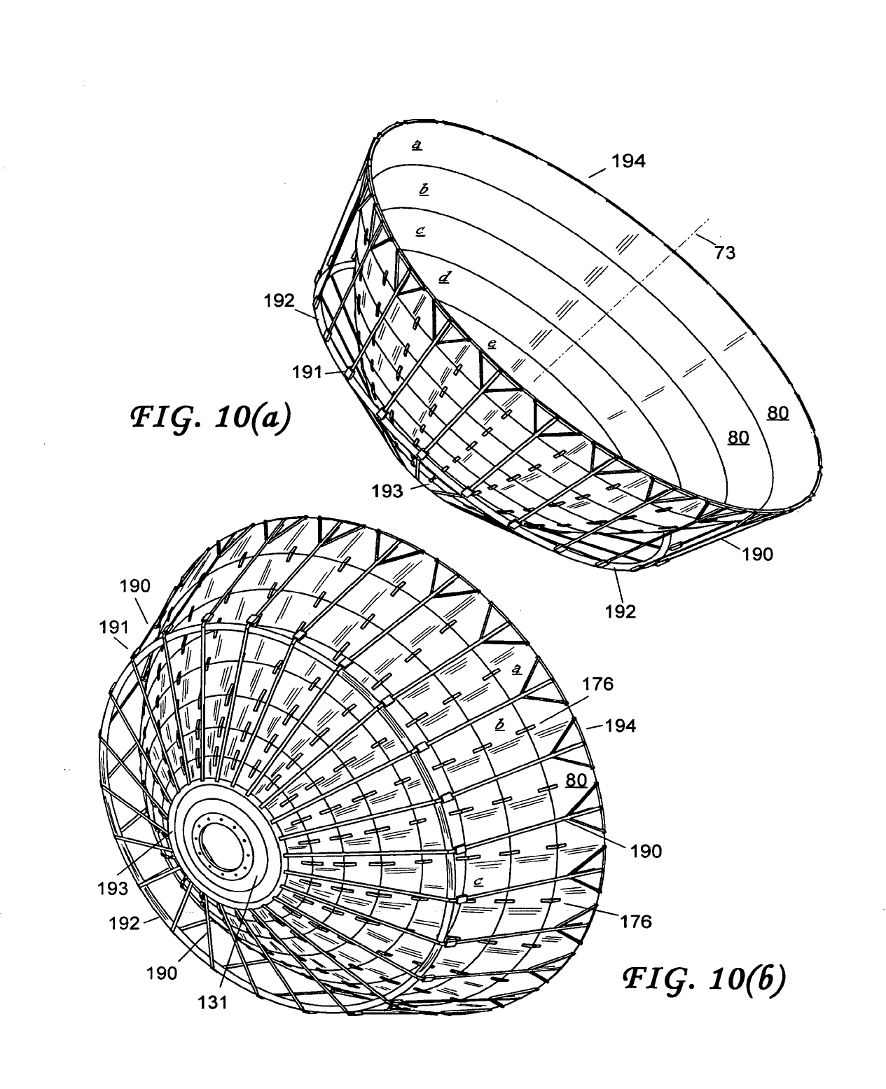

The absorber length h′ of the receiver tube comprises the embodied receiver tube's effective absorber length disposed so as to provide substantial heating of the HTF, and is preferably provided so as to efficiently absorb the reflected, preferably direct, solar rays propagating from each conical frustum of the embodied CCC, in FIGS. 9-10. Accordingly, the absorber length is preferably provided such that it is roughly equivalent or slightly longer than the envelope of parallel rays resulting from the paraxial rays reflected by each frustum, as depicted. In its first preferred embodiment, the absorber length h′ of the receiver tube is preferably such that 0.01D<h′<0.3D, and more preferably, 0.05D<h′<0.18D. A non-transparent region (69) of the receiver can comprise the mounting nipple of the hot-finger assembly, but preferably, in the case of high-temperature operation, is a coating or cover over the glass receiver tube.

It is pointed out that the relative diameter of the single-ended receiver tube, relative to h′ and D, in FIGS. 1, is depicted as larger in diameter than is typically preferred for purposes of clear representation. In the preferred embodiments, the diameter, d, of the hot-finger receiver tube (11), which is the fused silica tube containing and contacting the HTF, is preferably such that 0.001D<d <0.02D, and more preferably 0.004D <d<0.015D, wherein D is the diameter (or diagonal dimension in square embodiments) of the CCC reflector, or, equivalently, the larger diameter of the largest conical frustum's reflecting surface.

An axis of normal incidence (74) resides in a plane containing the optical axis 73 and the propagating solar rays, and is perpendicular to the optical axis, thereby designating the axis of normal incidence with respect to the substantially linear portion (as opposed to hemispherical portion) of the embodied receiver tube's surface, for the propagating solar rays that enter the receiver tube in the plane. For example, in FIG. 1, an axis of normal incidence (74) is contained in the CCC base plane (59). It is preferred that the conical frustums be constructed so that at least 90% of the solar radiation incident on the linear portion of the receiver tube is at an angle Θᵢ of propagation, relative to normal incidence, preferably such that 0°≤Θ≤60°. Preferably this is accomplished within the constraint that the radius of the CCC's central opening is such that this radius r, is less than 1 meter and greater than 2 d, though this is not a required limitation.

In FIG. 1, the conical frustums represented by the profiles A-F each correspond to a separate, stackable conical section with the distinct slope of the respective profile. In the preferred embodiments, the separate sections are stacked to form the embodied compound conical concentrator (CCC). Accordingly, an embodied CCC structure having profiles A-F may have, for example, the bottom-most section, F, removed or not employed, so that concentrated solar is received instead from conical frustums corresponding to A-E. In the same manner, a CCC constructed for a specific receiver absorbing height, h′, may have additional frustums stacked and attached to the top frustum, A, so as to provide the CCC with an effectively greater receiving area, and hence, in the preferred embodiments, a higher effective concentration factor. It is preferred in the present embodiments, in FIG. 1, that at least the uppermost frustum be appropriately extended to additionally provide irradiation of the hemispherical top (16) of the embodied receiver tube assembly. In this embodiment it is accomplished that the

As concentration factors of the embodied CCC's are easily obtained in the region of several hundred suns, it is preferred that a protective cylindrical shroud or sleeve (68) be transferred over the receiver tube during start-up and cool-down procedures, so as to absorb and deflect solar radiation from entering the transparent receiver tube preferably until tracking position is obtained.

In the preferred embodiments, there is a minimum clearance between the central axis (9) of the hot-finger assembly and the CCC reflecting surface, so that a central clearance opening (67) in the CCC with internal radius r, is provided. Additionally, it is preferred that this cavity is extended by an integral CCC-base cavity structure (118), preferably provided concentric to and opening to the central cavity formed at the base of the CCC.

The clearance cavity of the cavity structure is preferably provided so as to allow adequate clearance for both the single-ended receiver tube assembly and a retractable absorbing sleeve (68) that is preferably moved over the single-ended receiver tube during power-up and aligning the tracking mechanisms. Such protective shield is preferably telescoping in the preferred embodiments, but may alternatively be retracted to a position above the hot-finger assembly and within the cavity formed by the CCC structure, so that the protective sleeve (68) is in any case retracted to a position substantially removed to a position that will not block desired irradiation of the hot-finger assembly. The protective sleeve will preferably also incorporate a multitude of temperature and/or optical sensors for determining operating conditions near the sleeve surface prior to and after retraction of the protective retractable sleeve (68).

In addition, it is preferred that a top-hat heat shield (121) in the form of a circular concave IR mirror reside directly over the sealed end of the receiver tube, the heat shield reflecting emitted IR from the top—and preferably hottest portion—hemispherical end of the tube. The heat shield is preferably of a diameter slightly smaller than that which would result in occlusion of propagating rays from the upper most portion of the top frustum. In addition, a similar disk-shaped reflecting region comprising a metal reflecting film is deposited on a top disk-shaped portion of the hemispherical portion (16) of the tube, which is similarly limited in size to avoid occlusion of the uppermost locus of incoming rays.

In an alternative preferred embodiment, it may be desired that the irradiation of the receiver tube not be uniform, but that a particular gradient be realized in the solar flux and/or HTF temperature. Concentration of solar radiation by the concentrator onto the absorbing receiver tube may be readily implemented, by slight alteration of one or more conical section slopes, so that one end of the receiver tube is irradiated with greater solar flux relative to the opposite end. For example, it may be advantageous to realized hotter temperatures or higher heating of the top end of the receiver tube, so that emissive losses are minimized by requiring less heating distance at the hotter and higher-emitting end of the transparent receiver tube.

Unless noted otherwise, direct sunlight and incoming solar radiation of the present invention shall be that direct solar propagation that propagates, as paraxial rays, roughly parallel to the optical axis of the solar concentrator, typically with a divergence of less than 0.5 degrees.

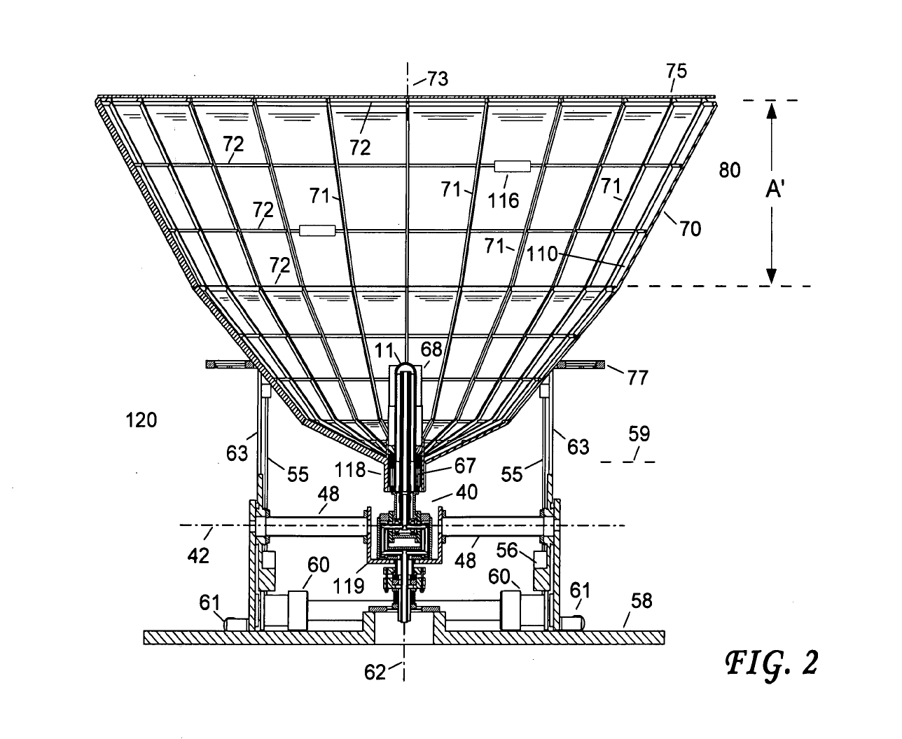

In certain cases, it may be found desirable to implement a CCC that provides a higher solar power to one end of the embodied receiver tube, wherein for example, emissive losses may be reduced by increasing effective solar concentration at the end of the HTF heating path, which is the top of the receiver tube in the present embodiments. Such a gradient in the effective solar concentration, along the length of the receiver tube, may be readily achieved through slight modification of one or more conical frustums of the present invention. The implementation of this concentration gradient may be realized, for example, through an according adjustment in the slope angle of and shortening height of the uppermost conical frustum of the embodied CCC structure, so that the top of the embodied solar receiver tube is thereby preferentially heated.

Whereas any tracking mechanism may be utilized for maintaining the concentrator with its optical axis pointed toward the sun, it is preferred that the tracker be economical in its construction so as to provide a low cost of ownership. This is provided in the present invention through the utilization of a tracking base that does not require expense pedestals, large arc elements, or massive gear assemblies. It is preferred that the base be constructed with heavy use of steel cabling. In particular, the embodied CCC/hot-finger tracking assembly (120) provides tilt and pivot movement wherein tilt and pivot axes are located a preferred distance below the CCC base plane (59), such plane defined by the bottom-edge of the reflective surface (110) that is provided by the lowest and smallest-diameter conical frustum, and orthogonal to the optical axis of the CCC, as described in previous disclosures by same author, and in FIGS. 1-2.

The single-ended receiver tube assembly and 2-axis rotating union of the previous embodiments are preferably utilized in conjunction with a concentric tracking concentrator disposed for allowing the high degree of solar concentration that is seen as most beneficial for the preferred high temperature molten salt HTF's and for high-through-put of lower-temperature HTF's such as oil or water.

A hot-finger/CCC assembly (120) of an earlier disclosed preferred embodiment, in FIG. 2, is depicted with aligned central axes (9) (73) (62) of the solar receiver tube, the CCC structure, and pivot rotation, respectively. The CCC/hot-finger tracking assembly (120), in FIG. 2, incorporates preferred embodiments of the previously described conical frustums, comprising a segment of sheet reflector material (78) that is formed into the embodied conical frustum's desired shape, in part due to the support of a conical frame of the frustum comprising conical frustum support struts (71) and reflector structural rings (72), which is preferably a round metal stock, that interlock into the support rings.

A primary concentrator support ring (77) provides main structural support of the assembled CCC structure, and is preferably composed of aluminum alloy, but is alternatively composed of steel, fiberglass, plastic, wood, or bamboo.

A 2-axis union enclosure box (119) provides mounting surface and housing for the 2-axis union, and is adjoined on either side and coaxial to the tilt axis (42) by respective steering nipples (48), which steering nipples connect the 2-axis union rigidly to the surrounding tracker base assembly, so that pivot rotation of the tracker base assembly (13) in the lateral plane will thereby steer, or rotate, the 2-axis union about its pivot axis (62), so as to rotate uniformly with the base and CCC in this axis of rotation. Since the single-ended receiver tube/union assembly is preferably attached to the CCC base in a semi-rigid manner, by way of the concentrator mount flange preferably interfacing the CCC base by linear bearings that allow only very slight relative motion of the receiver tube assembly with respect to the CCC structure in the direction parallel to the optical axis, it may be preferable in certain windy installations that the steering nipples provide some compliance in their linear direction, so that any strain in the structure does not incur a stress within the rotating union assembly. In addition, it is preferred that the

Mounted on steering nipples (48) opposite ‘Y’ struts preferably on the same rotating bearing/housing is a ballast weight (56) for providing a counterweight to the mass represented by CCC structure and attached single-ended receiver tube assembly that tilt about the tilt axis (42) opposite the ballast weight.

A pedestal (57) is provided in the tracker platform (58) that preferably provides the interconnection to the work-load, which preferably resides directly below the pedestal. In the case that the tracker base is disposed over a building that houses the work load, it is preferable that the pedestal is detachable from the base structure, so that the 2-axis joint assembly can be optionally lowered into the building for service. Connection between the pedestal/base and the HTF output connector (115) is preferably made via a high temperature alloy bellows (114) that allows for a non-rigid connection to the HTF connector. Rotating connection to the lower and rotatable insulated tube (45) is made within the lower-temperature HTF supplied into the annular supply passage (22), and so can be made with similar non-hermetic seals as rotating connections between insulated tubes in the other regions of the embodied 2-axis union.

The tracker platform (58) is a suitably flat and hard platform providing sufficient area for a base pivot track (64) that comprises the circular path of the base rotation casters (61), which are mounted at the four corners of the embodied square base structure. The mechanism for driving the pivot rotation of the base and attached CCC and single-ended receiver tube/union assembly is preferably incorporated in the caster modules, though driving the pivot rotation can be provided by any suitable drive mechanism of prior art trackers, including pivot drive means located in the central pedestal structure.

The primary CCC support ring (77) is supported on either side by “Y” struts (63) that rotate on bearing housings about the central steering nipple shaft comprising linear pipe sections of the steering nipples. the ‘Y’ struts are disposed to rigidly support a concentrator support ring (77) that in turn provides primary support for the CCC structure. It is therefore provided that the ‘Y’ struts, attached support ring, and CCC structure are allowed to tilt about the tilt axis (42). The position of tilt is provided by cables (55) attached to the ‘Y’ struts, which cables (55) are opposingly tensioned and spooled in or out by spooling of the stepper motor/winch assembly (60), determine the tilt position of the CCC structure and attached single-ended receiver tube assembly. The assembly of ‘Y’ struts and steering nipples is in turn supported on a square frame that houses the winch/stepper units, and rotates on the platform by virtue of driven caster wheels (61).

In the preferred embodiment, each conical frustum is constructed utilizing the preferred reflective metallic strip material, preferably comprising a rolled metal strip of relatively thin gage, preferably less than 2.0 millimeters thick, and more preferably between 0.2 and 0.8 millimeters thick, though other thicknesses outside this range may be readily utilized. The reflective sheet segment is preferably composed of joined subsections that are preferably welded, or otherwise joined along linear seams (79) that allow for the entire reflective sheet segment to be constructed into a single monolithic sheet segment.

In some alternative embodiments, the reflective sheet segments may be provided with fastening holes/features (101) that enable fastening the sheet segment to its respective conical frame. The fastening holes are further operational in providing registration of the sheet segment with the conical frame at a plurality of points, so that the reflective sheet segment (78) becomes a tensioning element in the resulting conical frustum, thereby enabling it to retain its desired shape while frustrating undesired flexure or distortion.

In the first preferred embodiments of the present invention, concentration factors of 200-1000 suns are preferred for allowing relatively loose tolerances in the construction and low cost in the materials utilized in the embodied CCC. In this way, it is envisioned that economical realization of solar-thermal, concentrated photovoltaic, and combinations of both can be realized with relatively inexpensive cost-of-ownership. Accordingly, the CCC of the first embodiments is constructed largely of linear metal stock that is readily available and is typically the least costly embodiment of a particular commercial metal alloy. In accordance with the first embodiments, low-cost is also achieved by use of tensioned steel cables, rather than rigid structural elements, where ever practical.

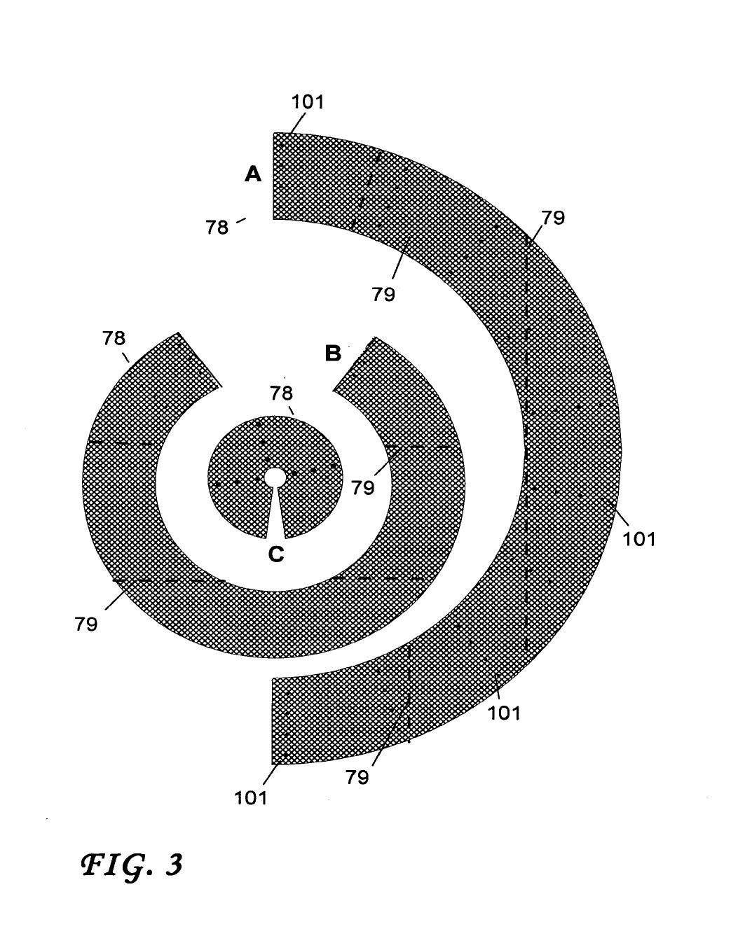

Accordingly, each reflective sheet segment (78), in FIG. 3, comprising the reflector material required for one conic frustum, comprising a flat sheet that is preferably formed prior to construction of the frustum. In some alternative embodiments, a function of the pre-fabricated segments of reflector material is in providing pre-determined registration features (101) that result in unique positioning and alignment of the reflector material when fastened by such registration holes to uniquely positioned fastener positions in the embodied support strut (71) and support rings (72). In this way, the reflector material is restrained to conform to the desired conical shape, and in addition, provides additional tensioning means for increasing rigidity of the frustum structure. With the placement of holes for fasteners in the reflector sheet, all dimensions and angle of the conical structure are uniquely determined, as the reflector sheet adds an additional tensioning structure. The flattened reflector material segments are typically larger in dimension than available rolled reflector material and are preferably constructed by joining linear pieces of rolled reflector material, preferably by spot-welding or otherwise providing a fused linear seam (79).

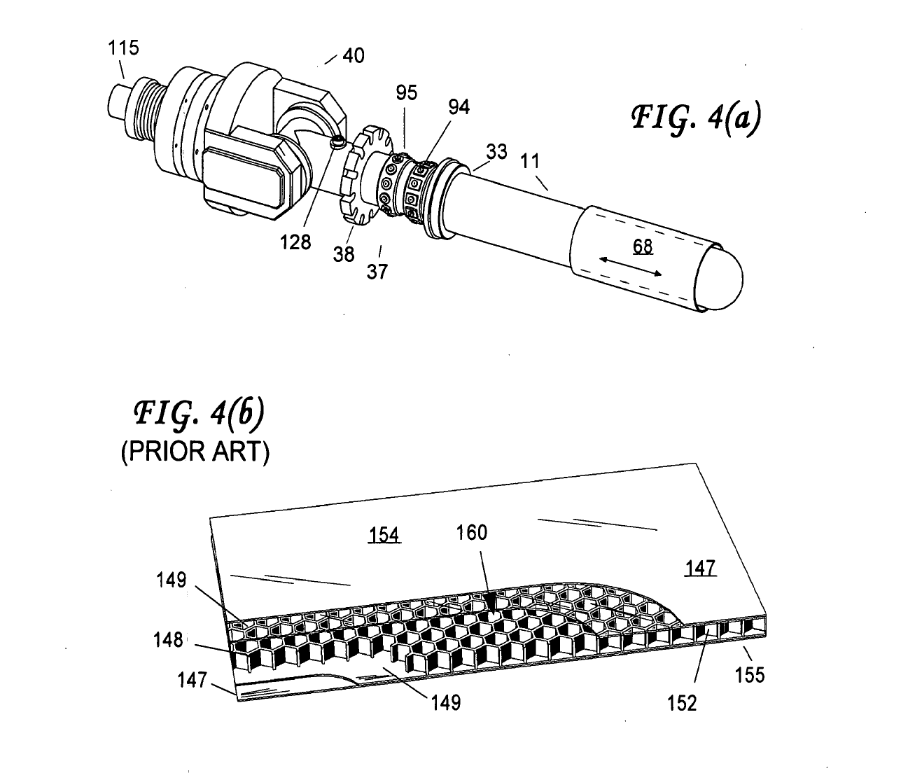

In FIG. 4(a), a previously disclosed, modified hot-finger assembly (utilized for a here for a MJPV assembly) is preferably protected by a retractable protective sleeve (68) for protection against undesirable irradiation during start-up, shut-down, tracking realignment, emergency shut-down, and other such circumstances. The protective sleeve may block light from entering the receiver tube by either absorption or reflection. In an alternative embodiment, the sleeve is partially transmitting—by incorporating transmitting surfaces or open slits—so as to allow some attenuated irradiation of the hot-finger assembly for assessing operating conditions prior to exposing the absorbing media of the hot-finger assembly to full irradiation. The protective sleeve is also usefully utilized to protect from potentially damaging weather, mechanical damage by sandstorms, and during transportation.

It will be preferred under certain circumstances that the protective sleeve be integrated into the receiver tube assembly (“hotfinger assembly”), so that mechanical translation of the protective sleeve is actuated by sleeve mechanical actuating means that are incorporated into the hotfinger assembly, such as by telescoping or pneumatic actuators. Having the protective sleeve and associated actuation mechanisms integrated into the hotfinger assembly allows for control of such sleeve actuating means to be powered by the same electrical interconnection that monitors sensors of the hotfinger assembly. Accordingly, there is preferably a CPV module electrical interconnect (128) mounted on the hotfinger assembly below, or in some cases above, the mounting flange, wherein such electronic control connector provides communication with a computerized logic system for monitoring temperature sensing means such as thermocouples, RTD's, pyrometers, transducers, mass flow sensors, and other sensors that are integrated into the hotfinger assembly for monitoring its operation, so that such sensing may provide feedback to a computer for monitoring and controlling mass flow, determining over-temperature conditions, non-standard operating conditions, etc, wherein such monitoring is performed in relation to one or more logic controllers that activate translation of the sleeve along the optical axis (73) to a protective position. While the present MJPV module, in FIG. 4(a), is embodied in conjunction with a two-axis feedthrough assembly, lower temperature operation (<300 C) will considerably reduce restrictions on feedthrough design, so that flexible bellows or tubing utilizing flexible synthetic materials may be utilized.

The CCC of the first preferred embodiments is preferably constructed utilizing materials and manufacturing processes that minimize manufacturing costs, while maintaining high precision and rigidity in a light-weight construction. These objectives are satisfied in the preferred embodiments of the embodied CCC structure through the implementation of embodied manufacturing process and frustum structure wherein cylindrical preforms are constructed from multiply layered systems, the preforms in particular comprising alternating layers of sheet metal and a hollow-core material layer, preferably an aluminum honeycomb core material.

Single-core, aluminum-based, honeycomb-reinforced panels of the prior art, in FIG. 4(b), are commonly manufactured and commercially available with a laminated aluminum core. The aluminum honeycomb core of the reinforced panel comprises a 3-dimensional structure wherein hexagonal cells of the honeycomb core are formed out of aluminum strip of width determining the depth of the cells. The honeycomb core (148) thus comprises a hexagonal structure composed of relatively thin aluminum sidewalls (152) that are periodically laminated and expanded to form hexagonal cavity spaces (160). This honeycomb core is typically sandwiched between two planar sheets of cladding sheet metal (147), which are adhered to the honeycomb core by typically an adhesive film (149) of an adhesive such as an epoxy or silicone.

Such Aluminum honeycomb-reinforced panels are widely available from multiple vendors worldwide. These panels are readily purchased from a large variety of vendors of such honeycomb panels, including Hexcel, Inc, Pacific Panel, Inc (US) Plascore (US, Gmbh), Paneltek Corp (US), Universal Metaltek (India). In-depth explanation of the various materials, processes, and structures that are utilized in such honeycomb panels are treated in numerous texts, including, “Honeycomb Technology: Materials, design, manufacturing, applications and testing” by T. N. Bitzer, which is included herein by reference, as well as by various technical and product data sheets available from Hexcel. Accordingly, such panel construction is embodied particularly herein utilizing aluminum honeycomb core structure in its preferred embodiments, whereas a variety of other materials and core structures may be utilized. The honeycomb panel construction has been used extensively in prior art solar reflectors wherein the honeycomb core (148) with its sidewall structure (152) is shaped so that a reflective material comprising the outer metal cladding (147) or “skin” is given an aspheric or similarly curved profile for purposes of providing a linear-trough solar concentrator.

In a preferred embodiment, the conical frustum sections are manufactured in accordance with a manufacturing method and various particular structural embodiments comprising rigidity-enhancing embodiments that may be used in conjunction with the preferred embodiments or in other, alternative embodiments utilizing circular solar concentrators. In addition to the frustum construction system of the previous embodiments, it is provided in the present preferred embodiment, that the conically formed reflector material of the previously embodied conic frustums incorporate a light-weight double-walled structure that preferably incorporates expanded honeycomb—or alternatively, other light-weight, expanded, metal mesh—that is sandwiched between two metallic sheet-metal walls (154, 155).

As previously described in conjunction with prior art honeycomb panels, the present preferred embodiment preferably incorporates a construction utilizing flat planar sheets comprising a double-walled enclosure reinforced by a core layer that is predominantly an open-space structure, most preferably having a honeycomb (hexagonal) network of supporting walls. sheet having mid-plane (151), though other low-density structured materials may be utilized.

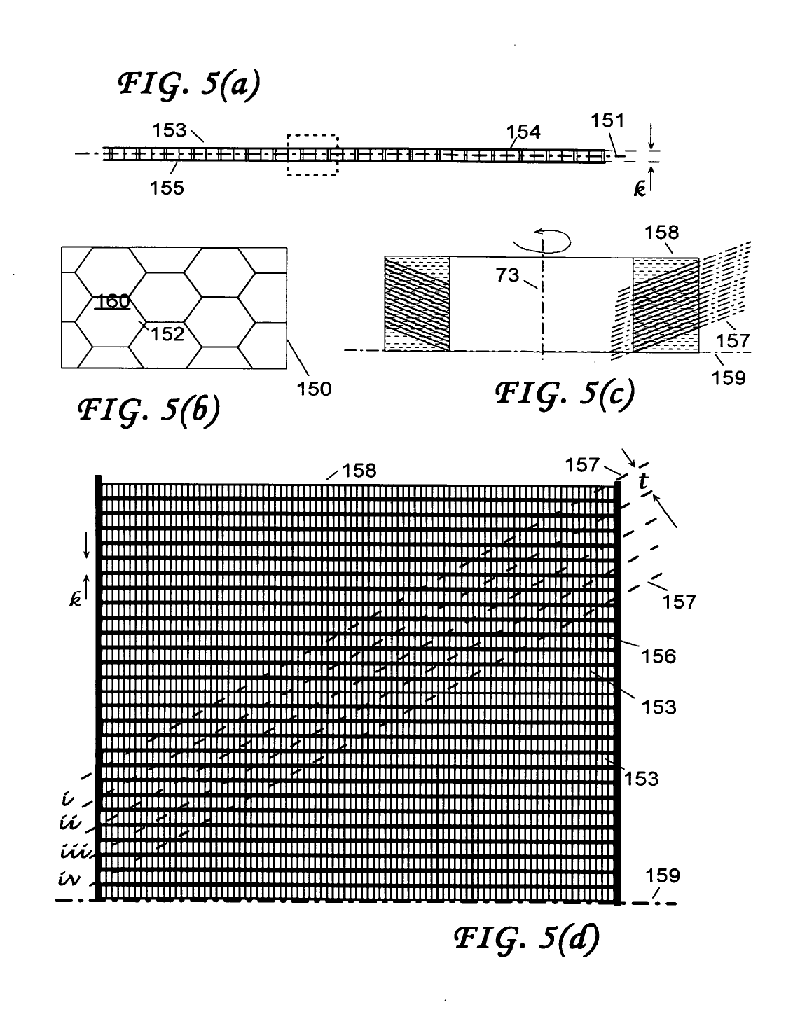

In particular, in the preferred embodiments, conic frustums of the invention are formed through successive sectioning of a multilayer preform, wherein the preform (158) preferably comprises a plurality of stacked layers of the flat planar, honeycomb-reinforced, sheets (153), in FIG. 5. Such flat sheets are preferably those currently commercially available, and preferably comprise a first planar surface (154) and a second planar surface (155) of the planar, honeycomb-reinforced, sheet, such first surface and second surface preferably comprising thin sheet metal, preferably aluminum. The planar sheet metal of the planar, reinforced sheet preferably comprises an aluminum alloy, or alternatively a stainless steel, other alloy, plastic, glass, or poly-ceramic material. The first and second surfaces of the planar reinforced sheets are preferably separated by a layer of a metal mesh or network material, preferably an expanded metal, and more preferably the embodied aluminum honeycomb structure, in FIG. 5(b), the expanded aluminum having vertical structural walls (152) of honeycomb structure and interior spaces (160) of honeycomb structure formed by the vertical structural walls, as is commercially standard. The thickness k of planar, honeycomb-reinforced, sheets are preferably—but not necessarily—less than the thickness t of subsequently formed self-standing frustums, and are accordingly 0.1 cm to 3 cm in thickness, though other thicknesses are readily utilized.

In this described parting of the toroidal preform, the number of frustum sections—i, ii, iii, iv, and so on—, in FIG. 5(d), that may be provided in the parting and laminating of a single preform is accordingly quite large, wherein the toroidal preform is preferably formed onto the rotating bed as a vertical cylinder having an axial depth of up to several or several tens of meters. Accordingly, a preform of the preferred embodiments may provide tens to thousands of individual frustums, depending on the optimum thickness, t, of the free-standing frustums that are formed by this process. Preferably the thickness t measured normal to inner and outer surfaces in a plane containing the optical axis, is such that 0.3 cm<t<10 cm, depending on frustum size.

In particular, an embodied multilayer preform (158) of the preferred embodiments preferably comprises a monolithic glued or otherwise laminated stack of such planar, honeycomb-reinforced, sheets, in FIG. 5(c-d). Accordingly the layers of the preform preferably comprise stacked planar layers of the reinforced sheet that each comprise double-walled, honeycomb sheets of the prior art, which are preferably adhered into a stack of such reinforced sheets by means of an adhesive, preferably an epoxy, or alternatively a silicone, thermoplastic, or any other suitable adhesive, such adhesive providing a solid bond between the respective surfaces of adjacent flat reinforced sheet (153), so that an interface (156) is accordingly formed between the planar reinforced sheets, such interface preferably comprising the first and second surfaces of the embodied reinforced sheet (153), and the adhesive utilized to bond these adjacent reinforced sheets, but may alternatively incorporate additional strengthening materials such as additional layers of sheet metal (preferably an aluminum alloy); or, alternatively, such interfaces (156) may comprise only a single metal sheet in such cases that the preform is constructed by simply alternating layers of an expanded metal mesh and single layers of a sheet metal. Alternatively, the toroidal preform may also be constructed with graphite composites (such as resin infiltrated graphite fiber), plastics, ceramics, poly-ceramics, or glasses. Also, it is not necessary that the reinforcing core be strictly hexagonal, as a variety of other reinforcing cores may be utilized, and alternative core layers comprising mostly open space with a regular lattice of supporting material may be utilized.

So as to efficiently provide the embodied frustum shapes of the previous embodiments, it is accordingly preferred that the preform be formed as a toroid, or cylinder, and that the resulting toroidal preform is formed onto a base (159) of a rotating table, so that the toroidal preform can be rotated about the optical axis (73) of a subsequently formed conic frustum, which axis is coincident with the central axis of the toroidal preform in FIG. 5(c).

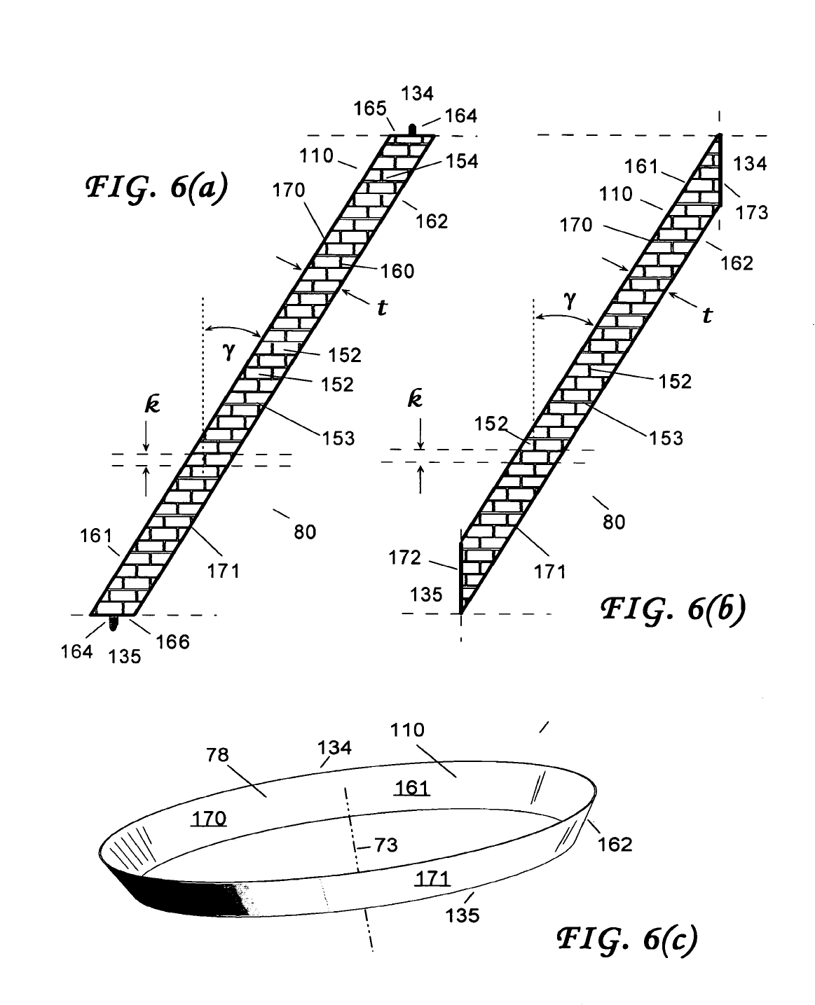

Once the toroidal preform (158) is formed, there is provided means for sectioning, or parting, of the preform into a series of, preferably, substantially identical conical frustums. The sectioning of the preform is provided at successively deeper parting lines (157) by a material cutting means that cuts the straight profile of the desired conic frustum profile, so that a cutting instrument providing the desired parting line accordingly provides a cut profile having the embodied linear profile, such cutting means preferably comprising an appropriately narrow scroll-saw blade, or alternatively a wire saw, laser beam, water-jet, or any other cutting means suitable for providing such linear cutting profiles in accordance with the embodied frustum profiles. Accordingly, the linear cut along a parting line (157) is advanced through the preform preferably by means of rotating the underlying rotating table and toroidal preform about the optical axis (73) of the frustum being formed. In this rotation of the toroidal preform, a frustum section of the preferred embodiments is accordingly separated from the previously embodied preform by the linear cutting means, so that a freestanding conic frustum having preferably parallel inner and outer parted surfaces (170) (171) is formed, in FIG. 6. Such parted surfaces accordingly comprise exposed structural elements including honeycomb walls (152) and interfacial layer (156) comprising the honeycomb panel cladding layers (154) 155) that were parted and accordingly exposed during the parting operation.

It is preferred that parted surfaces (170) (171) of a parted frustum of the present embodiments, formed in accordance with the parting lines (157) by the previously described parting operation, be utilized for aligning and supporting a subsequently attached, preferably metallic, flexible sheet material (161) (162), comprising a reflective sheet material (161) attached to the inner parted surface (170) and a second flexible sheet material (162) attached to the outer parted surface (171), in FIGS. 23(a-b)

It is accordingly preferred that the inner parted surface (170), be provided any desired finishing while still integral to the preform, since the rigidity of the embodied preform allows precise finishing of such parted surfaces, prior to the parting the respective frustum. Final finishing is preferably provided by laser trimming or similar material removal means along similar linear path as the parting tool.

It is additionally preferred that the flexible laminating reflector material (161) be applied to a finished inner parting surface (170) of the presently embodied conical frustum also prior to the respective frustum being parted from the preform, so that the frustum is preferably provided additional rigidity by the laminated reflector material prior to being separated from the preform.

Once a conical frustum section of the preferred embodiments is laminated with reflective material on its first parted surface (170) and subsequently parted from the cylindrical preform, thereby forming outer parted surface (171) comprising exposed surfaces of the parted preform, it is preferably flipped on its optical axis, and the outer parted surface (171) of the frustum section is then laminated with a backside material, preferably comprising the second laminating thin sheet metal, wherein adhesion is again preferably provided as an epoxy or silicone, and so that the inner surface (161) and outer surface (162) of the embodied frustum are accordingly formed by these laminated surface layers.

In the present preferred embodiment, the reflective frustum surface (110) is thus provided adjacent the inner parted surface (170) of the frustum by means of conforming and attaching the flexible reflective sheet (161) to this inner parted surface, such sheet having preferably less than 2 mm thickness, and adhered to the inner parted surface by means of organic adhesives, preferably an epoxy. Alternatively, other bonding means such as resistive or laser welding of interfacing metal surfaces may be utilized. The flexible reflective sheet material (161) preferably comprises a metal strip, preferably aluminum, with integral reflective surface already formed. Such reflective aluminum strip is available from Vega (Italy), Alanod (Germany), as well as other vendors. Alternatively the flexible reflective sheet material (161) may comprise any other suitable material, such as polymeric-based (e.g., Reflectech) or a stainless steel-based flexible material. In a preferred embodiment, the flexible reflective material (161) comprises aluminum sheet that has additionally a protected silver coating for optimum reflectance; for example comprising a thin film multilayer of sequence substrate/chrome/silver/zirconia.

Accordingly the flexible reflective material (161) thus imparts to the embodied frustum an inner-facing reflective frustum surface similar to earlier embodiments. Similarly, the second flexible metal sheet (162), preferably aluminum, is conformed and adhered to the outer parted surface (171) of the parted frustum by similar adhesive means, the second flexible metal sheet accordingly providing the outer surface of the finished frustum, and thus providing additional structural integrity and rigidity to the embodied frustum. The second flexible metal sheet is primarily for structural purposes, and may accordingly be provided with any additional structural attributes for enhancing structural integrity of the embodied frustum, including adhesion-enhancing surface finishes, vent-holes, etc.

Such free-standing conical frustums of the present embodiments may thus be effectively utilized in place of the conically formed reflective sheet (78) segments of the earlier preferred embodiments, while providing structural means that reduce additional costs of added support structures in the variously embodied hot-finger/CCC assembly, wherein the flexible sheet segment (78) of previous embodiments, in FIG. 3, is essentially interchangeable in form and function to the flexible reflective sheet (161) laminated onto the parted frustum, in FIG. 6(a-b), except that alignment holes are not required, and a polymeric adhesive is instead utilized. The reinforced frustums of the present embodiments are also found advantageous for being easily stacked in densely populated concentric volumes, leading to an according cost advantage in storage and transportation.

A conic frustum structure with inner and outer frustum surfaces formed by respectively the first, reflective sheet material (161) and second sheet material (162) will accordingly have upper and lower circular edges in accordance with the established form of a conic frustum. These upper and lower edges may be terminated variously, but are preferably terminated as either horizontal flat surfaces, or else by cylindrical vertical surfaces. Which of these two edge terminations is most effective will depend on the application. For example, in the first preferred embodiment, larger and stationary CCC's that primarily benefit from maximum uniformity in surface mating between adjacent frustums, may be preferably constructed with horizontal surface termination, in FIG. 6(a); whereas, in a second preferred embodiment, smaller CCC's, semi-portable CCC's, or CCC's wherein material and transportation costs must be minimized, will typically be constructed with the preferred cylindrical edge-walls (172) (173), in FIG. 5(b), such exterior edge-surfaces thus providing external surfaces that bridge the gap between inner frustum surface (161) and parallel outer frustum (162) surface at the respective top and bottom edges of the embodied frustum structure, in FIG. 6(b).

In addition to the finished inner and outer surfaces (161) (162) of the presently embodied conical frustum preferably comprising parallel conical surfaces, it is also preferred that top edge-surface (134) and bottom edge-surface (135) are parallel to one another, such top and bottom surface comprising alignment surfaces of the embodied conic frustum. Such top and bottom surfaces preferably comprise surfaces that result by finishing the respective top and bottom edges of the parted frustum with a correspondingly sized strip of sheet metal, though such surfaces may also be provided by exposing a planar surface of the imbedded interfacial layers (156) of the parted preform—e.g., such as the cladding layers of stacked honeycomb panels (155) (154). Thus, in accordance with the present preferred embodiments, parallel top and bottom edge-surfaces (135)(134)of the embodied frustum comprise top planar alignment surface (165), and bottom planar alignment surface (166) of frustum (80), wherein these planar-parallel edge-surfaces are both orthogonal to the optical axis, in FIG. 6(a). While it is preferred that the inner and outer frustum surfaces be substantially parallel to one another in the manner described, and that top and bottom edge-surfaces be substantially parallel to one another in the manner described, in FIG. 6, various alternative embodiments in which these pairs of surfaces are tapered or otherwise configured may be readily envisioned without departing from the scope of the invention. Other alternative embodiments may b envisioned wherein lower frustums are of greater thickness, t, than the upper frustums of the CCC.

Conversely, in accordance with another preferred embodiment of the edge-surfaces, in FIG. 6(b), the bottom edge-surface (135) comprises, in particular, bottom cylindrical alignment surface (172), and the top edge-surface (134) comprises, in particular, top cylindrical alignment surface (173), wherein these edge-surfaces accordingly comprise vertical alignment surfaces for subsequent mating to, similarly terminated, adjacent frustums of a CCC in the present embodiments, and as embodied in further detail later, in FIG. 9.

In the present preferred embodiment, it is accordingly provided that conic frustums of the preferred embodiments possess a sectional profile along its external surfaces comprising substantially a four-sided parallelogram, in FIG. 6(a-b), wherein such profile preferably comprises a sectional profile taken through a plane containing the optical axis of the embodied frustum. Additionally, the inventive conic frustum of the present embodiments is provided so that the inner reflective surface comprising a thin sheet of conforming material (whether such sheet be a single material, multilayer, or a composite) is supported by a multitude of the planar supporting surfaces (156) that contact or otherwise support the reflective layer, such planar surfaces preferably orthogonal, substantially, to the optic axis of the frustum in the first preferred embodiments. Additionally it is accordingly provided that the reinforcing expanded metal mesh of the preferred embodiments, comprising a honeycomb structure, comprises inner mesh walls (152) of the honeycomb structure, which are preferably parallel to the optical axis of the frustum, so that both inner mesh walls and planar support surfaces of the embodied conic frustum are preferably connected to the reflective material—or any integral multilayer structure thereof—at acute angles and complementary obtuse angles, in the embodied sectional profile. Alternative embodiments may optionally include profiles having normal angles similar to the planar reinforced sheet of the prior art.

Such reinforced, double-walled, free-standing, frustum structures of the present invention provide additional advantages particularly suited for application in the conic frustums of the present invention. Such frustum structures of the present invention are provided exceptional rigidity by virtue of the many non-normal angles provided in the resulting frustum structure, in FIG. 6, provided by the parting process of the present embodiments. In accordance with the preferred embodiments, a multitude of non-normal contact angles are provided between the preferred honeycomb structure, the inner surface (161) and outer surface (162) of the embodied frustum of the present embodiments, in FIG. 6(a). It is accordingly preferred that an angle y exist between the vertical walls (152) of the incorporated honeycomb structure and the preferably parallel inner and outer surfaces (161) (162), such that, preferably 10°<γ<80°, such angle measured in a major plane of the frustum (major plane defined herein as a plane containing the central optical axis). Such oblique angles, similar to advantages in “space frame” constructions, are found additionally advantageous for achieving exceptional rigidity and strength.

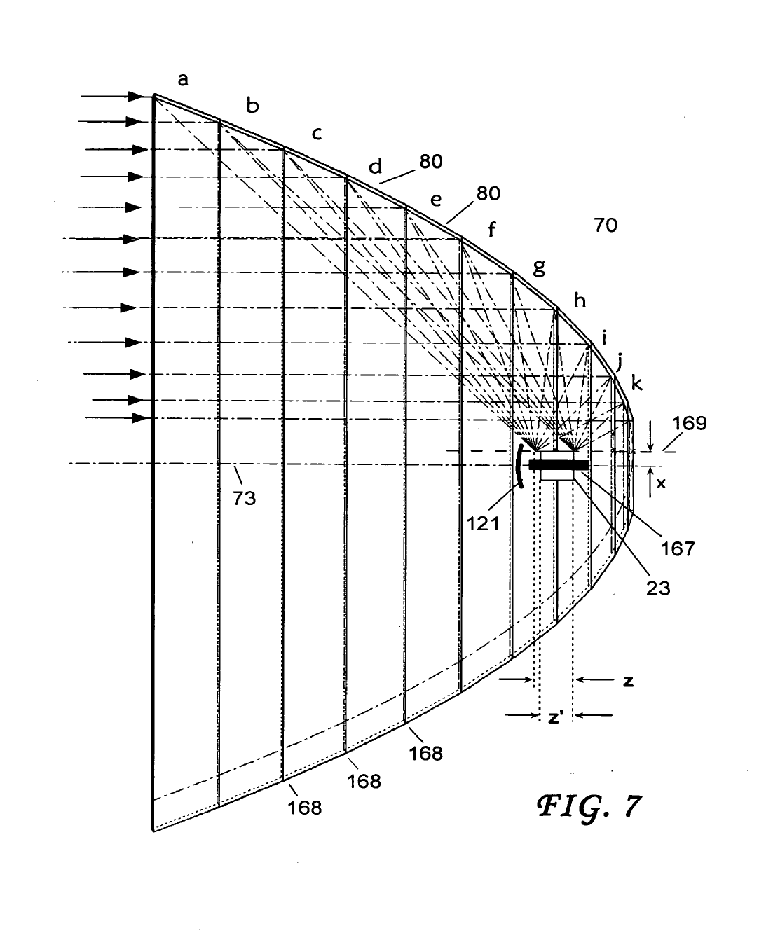

The stackable conic frustums of the embodied CCC structure are, in a preferred embodiment, provided with the reinforcing embodiments provided herein, in FIGS. 5-6. Accordingly, the top and bottom joining surfaces (134)(135) of each frustum in the embodied CCC preferably attach to adjacent conical frustums at the embodied planar and parallel surfaces comprising joining surfaces, in FIG. 6(a), so that such frustum interfaces (168), comprising top and bottom planar surfaces (165) (166) of adjacent frustums of the inventive CCC structure, are preferably orthogonal, in relation to the central optical axis of the CCC structure, in FIG. 7. It is preferred that such joining surfaces are additionally formed with alignment means comprising alignment pins (164) that mate to corresponding holes in the adjacent frustum edge-surface, so that joining surfaces of adjacent frustums are guided by such alignment means prior to contacting of such adjoining edge-surfaces of concentric adjacent frustums, and so that frustums are preferably guided by such alignment means so as to join in a unique concentric alignment. Alternatively, the parallel edge-surfaces, in accordance with FIG. 5(b), are coaxial to the optical axis (73).

In yet another further embodiment, in FIG. 7, the inventive CCC structure comprises a (N=11) stack of the embodied optically-reflecting frustums, the CCC mutually providing high optical power density within a volume comprising a cylindrical annulus concentric to the optical axis, so that, within a major plane (herein a plane containing the central optical axis), the mutual foci of the CCC reside along a displaced focal line that is displaced from the central optical axis (73) by a displacement x, where x may be a linear distance on order of centimeters to meters. In such alternative embodiments, the original absorbing tube and receiver tube are scaled with accordingly larger radii, and a greater proportion of the radiation from upper frustums (a-f) may be directed into the interior of the absorbing tube from above, as embodied earlier. Accordingly, it may also be seen that by appropriate adjustment of frustum angles, x may be rendered to provide a cylinder of radius x, or alternatively, the grouping of foci may resemble a cone, an hourglass shape, or a stepped profile.

An alternative preferred embodiment is further provided, in FIG. 7, comprising a second, inner absorber element (167) that is concentric to the tube axis (9) and preferably extends above the previously embodied absorbing tube (23) so that radiation arriving from reflection by top regions of the frustums will irradiate this inner absorbing element, which preferably comprises a tube, the tube containing the previously embodied insulated tube and return passage of the HTF. Such latter embodiments are useful in higher-N CCC's or wherein most radiation is provided from reflectors surface residing above the focal region, z.

Optionally, the grouping of foci from the frustums above the receiver tube may have a different, preferably higher, location than the grouping of foci resulting from frustums residing at or below the height of the receiver tube. Accordingly, frustums “a”-“f”, in FIG. 7, may accordingly provide a grouping of foci that is, on average, displaced from the grouping of foci determined by frustums “g”-“k”. For example. it may be preferred that light reflected from the upper set of frustums preferentially irradiate the top of the receiver tube, preferably so that substantial irradiation of the interior of the first outer absorbing tube (23) takes place, in addition to preferably irradiation of the alternative inner absorbing tube (167). Accordingly, in such alternative embodiments wherein the interior of the embodied receiver tube's first absorbing tube (23), of previous embodiments, is irradiated by the upper frustums of the CCC, it is preferred that the interior of this first outer absorbing tube be coated or otherwise terminated with a low-emissivity, IR-reflective coating, such as gold or any other appropriate material. In such alternative embodiments, the thermal insulating of the inner, return path, by insulating tube in earlier embodiments, so as to prevent cooling of the return HTF, may be replaced by the insulating function of such IR-reflective internal walls of the outer absorbing tube (23), as well as by an accordingly large annulus of non-flowing HTF that resides between the first outer absorbing tube (23) and inner absorbing tube (167).

In the present alternative preferred embodiment, there is accordingly an approximate length z of the cylindrical surface (169) of foci, wherein such cylindrical surface reduces to a line, as in previous embodiments, as its radius x goes to zero. In accordance with the present embodiments wherein solar radiation enters the interior of the absorbing tube (23) from its top entrance, the absorbing length z′ of the first absorbing tube (23) may be substantially equal or less than the surface-of-foci length z, whereas the second, inner, absorbing tube (167) may extend above the first absorbing tube (23) as well as above the surface-of-foci (169). In such latter cases, it may be seen that the effective absorbing length of the receiver tube need not be limited to the surface of foci as determined by one side of the CCC profile.

The inner absorber element (167) preferably extends above the previously embodied absorbing tube (23) so that radiation arriving from reflection from top regions of the frustums will irradiate this inner absorbing element, which preferably comprises a tube housing the previously embodied return passage of the HTF.

In a preferred embodiment, the consecutively stacked layers of honeycomb core material and the interleaved sheet metal interface layers are arranged so that the honeycomb core material of adjacent layers in the stack are disposed with an angular displacement, φ, relative to one another, wherein the angular displacement is preferably such that 5 degrees<φ<175 degrees, in the case that anisotropy of the mesh due to lamination is accounted for and the structure has two-fold rotational symmetry, and preferably such that 5 degrees <φ<55 degrees in the case that 6-fold symmetry of hexagons are assumed. Accordingly, this angular displacement can be with or without respect to anisotropies regarding a periodic lamination direction of the core material, or the lamination direction of the core in an unexpanded state.

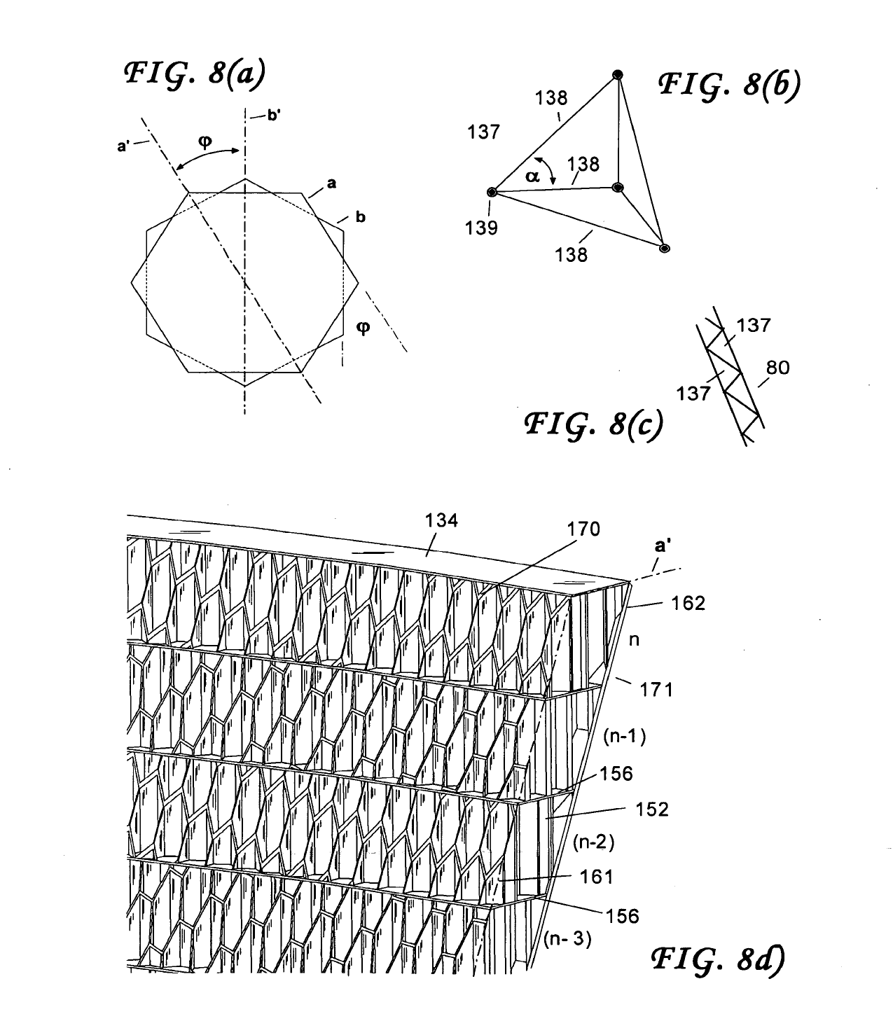

Additionally, it is preferred that the successive angular displacement of each adjacent core layer (148) with respect to the previous core layer, be provided in a cyclic fashion. For example, in FIG. 8(d). if the angular displacement of consecutive layers is +30°, −30°, +30°, −30°, +30°, . . . , wherein the designated vertices, a′, b′, correspond to the periodic lamination direction of the honeycomb core, then every other sectional profile of the resulting freestanding frustum (80) will have substantially identical orientation. Alternatively, the angular displacement may be such that the orientation of the honeycomb core repeats itself with a longer period, such as every third or fourth layer, and so on. Angular displacements are accordingly preferred so as to allow a repeating cycle of alternating honeycomb orientation in the successive layers of the n-layer preform and derivative clad frustum structure, wherein the angle may also be 10°, 12°, 15°, 20°, etc.

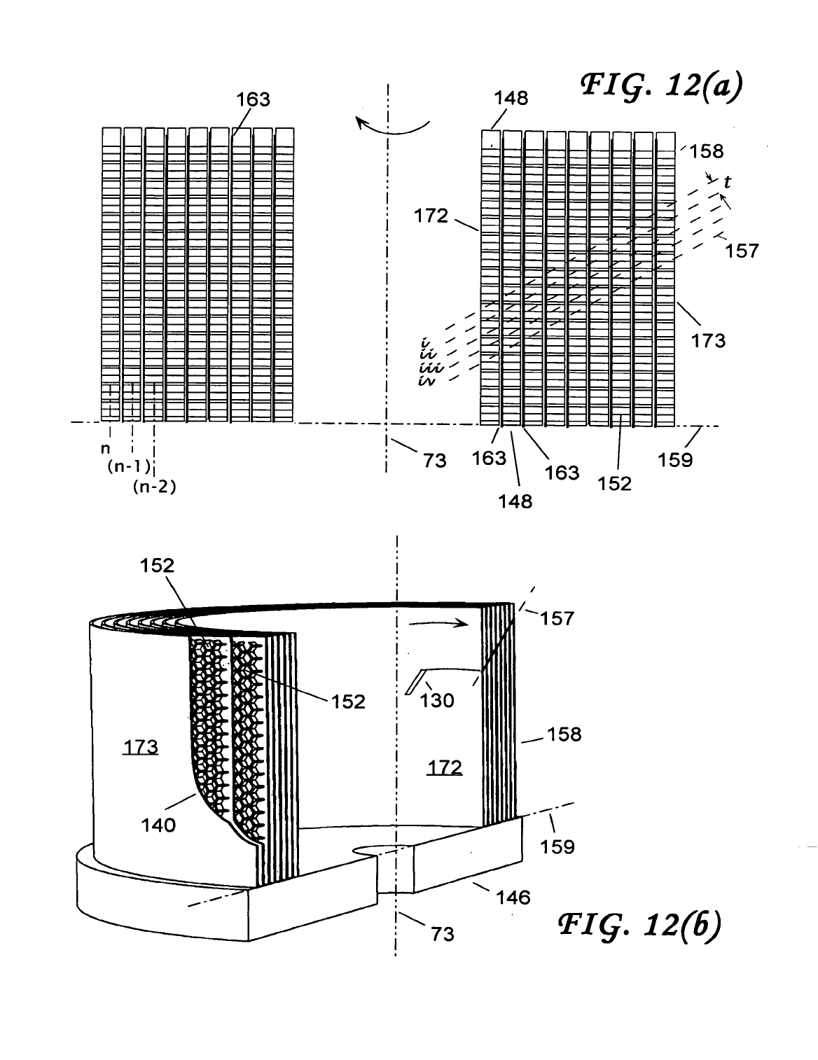

In either of the preferred preform embodiments, whether comprised of a stack of flat honeycomb sheets, or, alternatively, by the concentric cylindrical or wound sheet metal layers (163) that are disposed between adjacent honeycomb core layers of a later-embodied wound preform embodiment, in FIG. 12, it is in any case preferred that the inner reflective material (161) and outer frustum surface (162) both be laminated to the layered honeycomb core structure so as to result in tetrahedra, or tri-lateral pyramid, structures being formed in the union of the inner reflective layer (161), honeycomb core material (152), and interface layers (156). Such tetrahedral shapes are preferably formed as well as in the union of the outer frustum layer (162), honeycomb core walls (152), and interface layer (156); whether the interface layer is formed by the cladding layers (154) (155) of the stacked planar honeycomb sheets or by singular interleaved sheets,

A tetrahedron (137) or, equivalently, trilateral pyramid, will be defined here, as is uniformly presented in mathematics, as a pyramid having a base and three sides, or equivalently, a pyramid structure comprising four triangular facets, in FIG. 8(b). The tetrahedron accordingly is characterized by four vertices (139) that each define intersection points of three adjacent faces of the structure, or equivalently such vertices each comprise the intersection point of three line segments (138), of the total six line segments comprising a tetrahedron, wherein an angle, a, exists between each line segments of the tetrahedron, wherein preferably a is provided such that 15°<α<90°.

Such reinforcing tetrahedral structures provide extremely high rigidity to the resulting frustum structure of the preferred embodiments, resulting from an interlocking tetrahedral space-frame geometry, wherein the abstracted line segments of a tetrahedron coincide with a continuous length of solid material that intersects adjacent continuous lengths of solid material in accordance with the tetrahedral shape. The embodied tetrahedral structures are formed by alternately either honeycomb sidewall (152), interface layer (156), or a frustum surface layer (161)(162), so that each element contributes to the structural integrity of the frustum. It is not typically the case that the reinforcing tetrahedral structures will be “regular” and comprise equilateral triangles, since a variety of non-regular tetrahedral structures will typically be formed in any particular frustum of the preferred embodiments. Also, while it is preferred that reinforcing structures effectively formed in joining the reflective material (161)(162), the interfacial material layer (156) and honeycomb structure (152), be tetrahedra, various slightly truncated tetrahedral shapes may additionally result without departing from the scope or spirit of the invention. In the embodied conic frustum, such tetrahedra result in conjunction with both laminated inner frustum surface (161) and outer frustum surface (162), so that a 3-dimensional network of interlocking tetrahedral structures are realized, thus results in an according truss-like structure in the sectional profile of the embodied frustum, in FIG. 8(c).

Alternatively, an alternative embodiment utilizing different core material has a quadrilateral pyramid coordination formed by the three structural elements comprising reflective material layer, alternative core material layer, and interface layer, that may instead result in pyramid reinforcement structures having quadrilateral bases (a roughly square or rectangular pyramid base with four sides).

In conjunction with these preferred embodiments, a preform comprising stacked planar layers, in FIG. 8(d), is composed of at least several parallel layers of a honeycomb core material. These layers may have identical orientation, with respect to the hexagonal pattern, or other regular pattern, but preferably are rotated or staggered in this orientation through the depth of the preform, so that planes of consecutive core material have their axes of symmetry displaced relative to the next by an angle, φ, when viewed orthogonally to those planes, from above in direction of optical axis as viewed in the z-direction along the, in FIG. 8 (a), adjacent honeycomb core layers will be disposed with an angular displacement, φ, relative to on another. Accordingly, a single free-standing frustum of the preferred embodiments will comprise n consecutive layers, [1, 2, 3, . . . (n-2), (n-1), n], in FIG. 8(d) of the honeycomb layers, wherein n is such that, preferably, 3<n<100.

As in the case of prior art honeycomb panels there is preferably silicone, or other, adhesive (186) is preferably utilized for laminating the reflective layer (161) comprising the inner surface of the completed frustum, as well as the outer material layer (162) comprising outer surface of the embodied frustum, to the respective parted surfaces (170) (171). Inner and outer frustum surface layers (161) (162), laminated to the respective parted surfaces (170) (171)of the parted honeycomb-layered core structure, are preferably also finished at their interface to the top and bottom edge-surface layers by a resin bead (188), preferably silicone or alternatively and epoxy, that is preferably disposed along the seam formed between frustum edge-surface and the reflective material, as well as the seam formed between frustum edge-surface and outer sheet metal frustum layer (162), in FIG. 9.

A CCC of the present preferred embodiments is preferably assembled in accordance with assembly means, in FIGS. 9-11, wherein a CCC structure assembled from the honeycomb-reinforced frustum embodiments, in FIGS. 5-6, is readily assembled and disassembled, which is preferred for applications wherein such characteristics as portability, ease of maintenance, and retract-ability, are of relatively high value.

More preferably, in the present alternative preferred embodiments, in FIG. 9(a-b), frustums having previously embodied bottom edge-surface (135) particularly embodied as lower cylindrical alignment surface (172) and top edge-surface (134) particularly embodied as upper cylindrical alignment surface (173), wherein such concentric and cylindrical edge-surfaces are preferred in a telescoping embodiment of the inventive CCC.

What will be generically referred to herein as “interlocking” mechanisms are those means whereby adjacent frustums are fastened or aligned with respect to each other, preferably using alignment means comprising top and bottom alignment surfaces. The adjacent frustums are preferably fastened with regards to one another by means of a plurality of fastening locations (175) positioned about the periphery of each circular interface (168) between respective upper and lower alignment surfaces of the respective joined frustums.

Preferably, the interlocking mechanism between adjacent frustums of the CCC include a plurality of lower clamp structures (181) that are integral to the bottom portion of the higher frustum of the interlocking pair, each lower clamping structure interlocking with an upper clamp structure (182) that is accordingly integral to the upper-most region of the lower frustum in the frustum pair.

Clamp region (175) containing preferred clamping means for registration of adjacent frustum surfaces with respect to each other incorporates a clamp mechanism (176) that preferably provides clamping means that are operable in determining alignment of frustum surfaces, including preferably a retractable spring-loaded clip (177) that engages against locking surface (179) within the clamping mechanism once the two frustums to be mutually aligned, wherein the two respective frustums that are interlocked by the clamp mechanism are brought substantially into the preferred aligned position with respect to optical concentration. There is also preferably disposed a polymeric edge-surface layer (187), comprising essentially a polymeric liner, on at least one of the aligning surfaces that protects and guides the alignment surfaces of the respective frustums relative to one another. The interlocking mechanisms also preferably incorporate a clamp stop surface (178) that provides a limiting stop for extension of the telescoping frustum assembly.

The clamping/interconnect means embodied are intended for purposes of teaching the invention, whereas a wide variety of clamping mechanisms may be found effective and in fact preferable under various specific circumstances. For example, joined frustums may be locked into position relative to each other by virtue of keyed alignment surfaces utilized in a twist-lock mechanism whereby rotation about the optical axis of one frustum relative to the adjacent frustum engages interlocking surfaces. Similarly, an alternative clamping mechanism can comprise a plurality of spring-loaded interlocking pins that are translated tangentially to the frustum alignment surfaces by an equal number of guiding surfaces. Accordingly, a large variety of interlocking and clamping mechanisms may be envisioned.

Assembled CCC's formed of stacked frustums in accordance with the previous embodiments are preferably held rigidly in position by tensioning means that compressively load the CCC along its optical axis, so that a tensioning force exists that pushes the top frustum and bottom-most frustum of the CCC toward one another along the optical axis. In this way, compressive forces are distributed evenly around the perimeter of each frustum, and the CCC is maintained with a high degree of concentricity in its optical performance.

Accordingly, CCC straps (190) are preferably utilized to provide tensioning means for mechanically loading the CCC along its optical axis and are preferably a thin flat, flexible, metal strap of 0.02-1.0 mm thickness. Such straps are preferably fastened along the upper most rim of the CCC's top frustum, and run to a lower fastening means adjacent the bottom base structure (131) of the CCC, so that the straps, when pulled tight, pull the interlocked frustums of the CCC together under a compressive force.

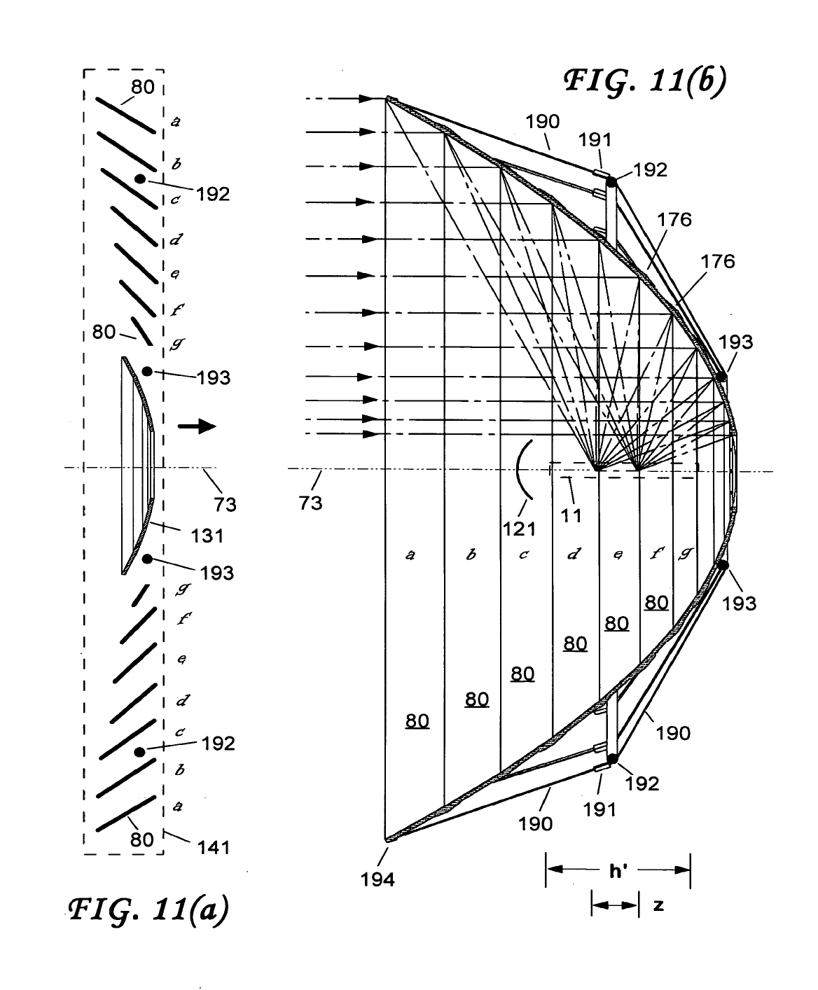

A CCC lower strap tensioning ring (193), which resides concentric to and registered against the CCC base, provides an array of fastening positions for the multitude of CCC straps (190) so that the lower tensioning ring applies compressive pressure to base through tensioned strap interconnections to the oppositely positioned CCC upper interconnection means (194). Upper strap interconnections (194) fasten the straps to an upper tensioning ring, which is preferably a relatively thick upper edge-surface of the top-most frustum in the embodied CCC. Upper interconnects also preferably comprise load-spreading structures so that tensile loading of the straps are transferred evenly to a corresponding compressive loading of the adjacent portion of the uppermost frustum's top edge at multiple, regularly spaced positions. According such load-spreading means of the CCC upper strap interconnect preferably comprise an extended structure utilizing truss-like members for attaching to CCC upper strap fastening means. A resulting CCC structure utilizing tetrahedra-reinforced frustums in conjunction with the embodied compressive strapping and interlocking mechanisms, in FIGS. 10-11, will preferably incorporate separate pre-cut segments of reflector material, as embodied in the earlier CCC embodiments, in FIG. 3, whereas the additional support members of those earlier CCC embodiments are preferably not incorporated into the tetrahedra-reinforced CCC of the present alternative preferred embodiment.

In a telescoping embodiment of the inventive CCC structure, frustums, marked a-g, and base unit (131) are thus disposed so as to be readily condensed into a retracted form, in FIG. 11(a), so that the components of the embodied CCC may be shipped or stored within a transport container (141) of considerably reduced volume, whereas the assembly of frustum and base unit may be extended in a telescoping fashion, in accordance with the vertical edge-wall embodiments, in FIG. 6(b), and clamping mechanisms previously embodied. The CCC base unit (131) is preferably formed as an integral and rigid piece comprising the lower-most sections of the reflector, preferably including the first, innermost, three frustum surfaces of the CCC in its machined surfaces. Circular bolt-pattern formed in the base unit (131) provides corresponding mounting means for the preferred solar-thermal, or alternative PV, receiver tube assembly, similar to mounting base means (118) in previous embodiments, in FIG. 2.

In the contracted form, the telescoping concentrator is preferably expanded to its extended form, in FIG. 11(b), by successively raising each frustum, consecutively or simultaneously, so that each frustum interlocks to the immediately inner and adjacent frustum by an interlocking mechanism, wherein the outer frustum is guided by preferably plastic-terminated surfaces. The interfacing region between adjacent frustums is preferably occupied by a polymer lining (187) attached to at least one edge surface, for prevention of debris and ease of disassembly. A variety of automated means may be readily incorporated for contracting and extending the assembly by those skilled in the art.

After the telescoping CCC assembly is expanded to its expanded state, in FIG. 11(b), tensioning means are preferably utilized for compressively loading the CCC along its optical axis. In particular, it is preferred that a plurality of flexible straps—metal or alternatively fabric or plastic, or any suitable material—extend between the upper region and lower region of the CCC with tensioning means so as to bring the straps under tension, thereby bringing the CCC structure under compressive force. CCC tensioning ring (192) is disposed intermediate to and concentric to the upper and lower strap fastening means, so that the tensioning means preferably comprise a spacing means for spacing the straps uniformly from the CCC structure, such spacing means preferably comprising CCC tensioning ring (192), such that the ring uniformly increases tensile loading of the straps by advancement of the ring downward toward the CCC base until a desired tensile loading of the straps is realized. Such tensioning means will preferably also include CCC tensioning clamps (191) that preferably comprises a clamping device that determines the position of the tensioning ring. Accordingly, advancement of the tensioning ring downward uniformly provides a commensurate tightening, or tensile loading, of the straps, thereby compressively loading the stack of interfacing frustums.

It is also pointed out in conjunction with the present embodiment that, as previously indicated, the absorber length, h′, may be considerably longer than the length, z, of abstracted line or cylinder corresponding to line or surface of highest solar concentration in accordance with the embodied CCC. Accordingly, the embodied CCC is also effective for concentration of indirect sunlight by means of providing a longer absorbing length in the absorbing media of the receiver tube than what is necessary to receive direct sunlight directed along the optical axis. The CCC tensioning ring (192) is also a preferred means of fastening to mounting means of a tracker, such as to an equatorial mount.

In an alternative embodiment, the preferred hollow-core aluminum-based frustums are parted from an alternative preform construction comprising vertically oriented honeycomb—or other suitable mesh—layers, utilizing, rather than the previous horizontal-planar orientation, in FIG. 6, instead a wound preform, in FIG. 12, comprising preferably a series of concentric sleeves of sheet metal interspersed with the hollow-core material, though a spiral formation of a continuously wound structure may be envisioned. This concentric arrangement is an alternative means of obtaining the tetrahedra-reinforced conic frustums of the preferred embodiments, similar to the preferred aluminum honeycomb core of the preferred preform construction in previous embodiments.

The alternative wound preform results in a major section of the resulting annulus, in FIG. 12(a), with cut-away region (140) revealing interior honeycomb core layers. As in previous preform embodiments, a sheet metal interface layer (163) and honeycomb core layers (148) of the wound preform are preferably of substantially constant thickness yielding frustums with roughly parallel inner and outer frustum surfaces; preferably with a resulting inner core of the resulting conic frustum comprising a plurality of support members that are alternately perpendicular and parallel to the optical axis of the embodied frustum. Hot-pressing of the wound preform of the present embodiments is preferably performed in an isostatic press using plastic bagging material in accordance with accepted practices, or alternatively by methods performed in conjunction with wound honeycomb structures of the prior art, such as provided by Hexcel Corp..

As in previous embodiments, linear cutting means (130) for parting the preform may be performed by a variety of cutting means, including but not limited to ultrasonic cutting blades, wiresaws, bandsaws, and acid string saws. Alternatively, the toroidal preform may be left stationary and cutting means rotated about the preform to produce the conical frustum. Mitered cuts made into the preform may also be performed on a turret lathe, boring mill, or other such conventional tools common to large machine shops.

Also, finishing of parted perform surfaces may be performed by any suitable method of the art, including wet-sanding methods commonly used in finishing honeycomb materials of the prior art, though laser-trimming, electro-etching, chemical polishing, or any other appropriate finishing method may be utilized, utilizing the circular rotating table (146) for these finishing stages in the usual manner.

Frustum core structures of the present alternative embodiments using wound preforms provide similar tetrahedral reinforcement and frustum structures similar to previous embodiments, and accordingly are similarly laminated with the inner and out frustum surface layers using similar bonding means such as silicone or epoxy interfacial adhesives.

As previously discussed, hollow core panels utilized in the construction of the inventive conic frustums are not limited to strictly aluminum and adhesive construction of the core or cladding material, or to layered honeycomb interior structures. For example, other materials utilized may include those commonly used in hollow-core panels of the prior art, such as graphite, titanium, stainless steel, paper, plastics, Teflon, TFE, polyimides, polyan, Nomex, Kevlar, polyvinylchloride, ABS, PEEK, Ultem, etc., and particularly wherein the honey comb core comprises various multilayer laminates of these materials. Whereas, frustums may be constructed of graphite-reinforced composites, aluminum hollow-core construction is preferred for both cost and environmental cycling resistance.

Fabrication of the core may be likewise conducted by a variety of bonding or lamination means, such as established and utilized in construction of commercially available hollow-core materials, including laser welding, resistive welded, adhesive bonding of corrugated metal, etc.

A variety of core constructions is available, and may possess mechanical characteristics that render such core material more suitable for the horizontal-planar construction, or alternatively more suitable for the wound construction of the embodied preforms. For wound preforms, various core materials are available that allow relatively high curvature of the core material. For example, Hexcel provides a variety of such alternative core materials including “Flexcore,” and others include “Doubleflex”, Benoflex”, Ox-core, reinforce honeycomb, “Doubleflex”, Benoflex”.

Likewise, the interior core of the preferred planar hollow-core sheet is not limited to strictly honeycomb cores, as a variety of alternative core structures may also provide adequate rigidity, such as those comprised of hexagonally stacked tubes, octagonal structures, cubic structures, “square cell,” etc.

Concentric CCC-based solar concentrators of the preferred embodiments provide advantages, relative to similar concentrators, in part due to significantly lower shipping costs that are possible with the stacked-frustums approach embodied herein. In a preferred embodiment, the hollow-cored frustums of the present stacked CCC structure are stored and shipped in a condensed/collapsed form, and wherein many component frustums corresponding to a large multitude of CCC's are stacked along the optical axis of the CCC for stowage in a condensed volume (141).

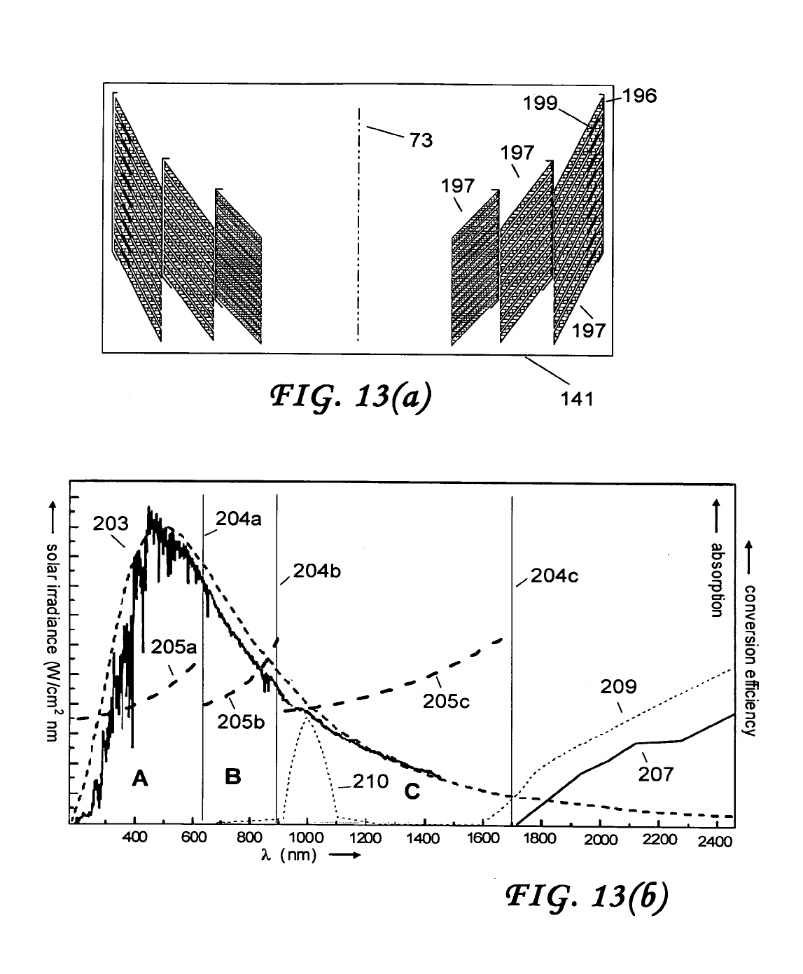

Since the embodied conic frustums are preferably formed separately, frustums of substantially identical diameter and slope are stacked together in shipping containers (141) that are disposed for containing and shipping at least several concentric stacks of the embodied frustums, so that the same amount of cylindrical volume required to house one CCC of the embodiments may be utilized in shipping and storage to contain a large multitude of the same CCC, in unassembled form, in FIG. 13(a). In addition, CCC's constructed of frustums having cylindrical edge-surfaces, in accordance with earlier embodiments, may accordingly be condensed into concentric stacks of frustums, wherein each stack comprises a multitude of one frustum size. Accordingly, a multitude—for example, one hundred—of substantially identical CCC's having a total of seven frustums each can be contained, stored, and shipped, as a concentric arrangement of seven concentric stacks, wherein each stack comprises a multitude of one of the respective seven frustums of the seven-frustum CCC, and so that the stack (197) of frustums comprises, for example, one-hundred or more substantially identical frustums. Preferably each shipped or stored stack is interspersed with frustum separating spacers (199) and wrapped around its periphery with a stretched plastic wrap or other packaging means (196). Of course, assemble CCC's may also be stacked as well for shipping purposes, though with less resulting packing density.

In a another alternative embodiment utilizing photovoltaic modules and receiver tubes, a multi-junction photovoltaic (MJPV) receiver tube, as embodied in FIGS. 4(a) and FIGS. 13-15, as well as in the prior disclosures cited herein, is modified to provide optical shielding of the MJPV module by an appropriate HTF, wherein the HTF is preferably a fluid with absorption characteristics that absorb ancillary optical radiation from the incoming solar spectrum, wherein such ancillary optical radiation is radiation that is outside of or in excess of the usable spectral bandwidth of the MJPV arrays. As is well understood, a typical MJPV array absorbs several adjacent regions of the available solar spectrum through utilization of several semiconductor junctions of distinct compositions and crystalline structure wherein one junction provides useful conversion of one region of the spectrum by virtue of its band-gap residing at the low-energy end of the respective absorbed region. In FIG. 13(b), an exemplary terrestrial solar spectrum (203) converted by the MJPV may correspond to conditions at sea-level, high-altitude, direct-sun, or diffuse light conditions.

In contrast to earlier embodiments utilizing photo-absorbing media in a circulating molten salt, wherein transmission of solar radiation through the salt is substantially absorbed and/or attenuated throughout the visible and near-IR spectrum, preferably so that the photo-absorbing salt suspension absorbs most of the incident power across this region of the solar spectrum; in the present embodiment, a majority of solar radiation incident on the presently embodied MJPV/CHP tube that is in the visible and near-IR is transmitted by a relatively low-temperature (less than 300 Celcius) HTF so as to be absorbed by absorbing surfaces comprising the MJPV module.

For example, three regions A, B, C, of the spectrum are accordingly absorbed by a three-junction MJPV wherein each junction is characterized by an associated band-gap energy (204a, 204b, 204c), and each particular junction of the MJPV has an associated energy conversion efficiency (205a, 205b, 205c) provided by the specific junction of the MJPV that is disposed for absorption of the respective spectral region (A,B,C), in FIG. 13(b),

In the present embodiment, the HTF possesses a HTF spectral absorption feature (207) that comprises optical absorption of the solar spectrum by the HTF with regards to the near and far infrared (IR), typically in the spectral region of 1.5 to 10 micrometer wavelength.

Also, in the present alternative embodiment, there is also an adjustable HTF additive added to or removed from the base HTF fluid, the HTF additive having an HTF-additive spectral absorption feature (208) that comprises a second optical absorption characteristic, the second optical absorption characteristic preferably providing an increased absorption of the solar spectrum by the HTF-additive with regards to the near-IR and far-IR, preferably in the region of 1.4 to 10 micrometer wavelength, and preferably also includes additional HTF-additive spectral absorption peak (209) that comprises optical absorption of the solar spectrum by the HTF-additive in a spectral region (preferably region C) of the MJPV. Particularly, the additional absorption peak (209) of the HTF-additive is preferably in the short wavelength portion of the spectral region absorbed preferentially by a Ge junction of a Ge/GaAs/GaInP MJPV, wherein such spectral absorption peak is preferably provided by an HTF-additive comprising water, or, alternatively, a similar absorption singularity can also be provided by commercially available silicone oils.

Accordingly, IR radiation in the incident solar radiation that is unused for electricity generation by the MJPV is absorbed preferentially by the HTF, so that useful heating of the HTF is provided after the fluid has already passed through the interior tube (123) where cooling of the MJPV is provided by heat transfer to the HTF. Preferably the HTF thus enters the cylindrical return passage (211) after undergoing an initial heating within the MJPV-cooling portion of the circuit, so that the HTF preferably is already heated to a temperature of between 50-200 C, depending on the type of MJPV used and other specific requirements of the installation. The HTF is then further heated in the return passage (211) due to both the absorption properties of the HTF, as well as due to the heating of an adjacent, apertured, absorber coating (217) that is disposed on a surface of the concentric tubes forming the return passage.

In particular, it is preferred that the HTF be passed through a substantially transparent envelope disposed directly infront of the MJPV array, so that incoming solar radiation passes through the interior of the HTF fluid prior to irradiating the MJPV, and wherein the HTF absorbs the infrared portions of the solar spectrum comprising wavelengths longer than wavelengths corresponding to the smallest band-gap of the MJPV. For example, if the MJPV comprises a Ge/GaAs/GaInP 3-junction MJPV, then the longest wavelength usefully converted to electrical power by this MJPV is typically that corresponding to the approximately 0.67 eV bandgap of Ge. Accordingly, a HTF of the current preferred embodiments would provide relatively high absorption of IR solar radiation corresponding to the infrared spectrum of photon energy less than 0.67 eV, in FIG. 13(b). Such HTF properties are preferably provided by a glycol, and more preferably ethylene glycol. Alternatively, a large assortment of alternative HTF compositions may be utilized in the present embodiments. For example, silicone oils, glycerol/glycerin, soybean oil or other vegetable oils, and any other oil or fluid compatible with preferred 100 C-plus operation. In certain alternative embodiments, gaseous or vaporous heat transfer media may also be envisioned. In the present embodiment, the second absorbing liquid comprising HTF-additive is added to or subtracted from the HTF so as to modify its absorbing properties in real time, in response to local solar conditions, as well as potentially in response to changes in the load requirements for delivered energy of the MJPV/CHP receiver tube so that relatively more electricity or relatively more thermal energy may be delivered in accordance with the amount of the HTF-additive that is incorporated into the HTF solution. For example, the use of an ethylene glycol with its high water solubility allows for the addition and removal of water for modifying the absorption properties. Such adding and subtracting of water content may be readily accomplished by various known desiccation means in the fluid circuit. In particular, it is preferred that the absorption-modifying HTF-additive provide absorption within the active spectral region of the MJPV, preferably in the long-wavelength region of a Ge/GaAs/GaInP MJPV, where photon flux in that region is in excess of that required for current balancing, and thus adds unnecessary heating of the MJPV under normal operating conditions. Various other components of the PV modules, including protection diodes, specific die-mount compounds, wire-bonding schemes, specific die-edge termination means, etc., may be incorporated within the embodied MJPV modules by those skilled in the art and as is commonly taught in the art.

In particular, the present alternative embodiment utilizes a similar tubulated enclosure as in the previous MJPV/CHP embodiments, with an inner transparent tube (214) that separates HTF return passage (211) from the PV modules (85), the inner transparent tube having an apertured absorber coating (217) formed on at least one of either inner or outer surfaces of the transparent tubes, preferably the outer surface of the inner tube (214). Accordingly, a HTF return passage (211) is formed between the inner transparent tube (214) and outer transparent tube (215).

The outer transparent tube (215) thus forms an outer concentric wall of the HTF return passage (211), so that the preferably transparent returning HTF preferably forms a continuous cylinder of flowing liquid in the according cylindrical volume of the embodied HTF return passage.

Accordingly, the absorbing coating (217) that is patterned with apertures is preferably formed on the outer surface of the inner transparent tube (214) so that, in addition to preventing unnecessary irradiation and heating of the front-side bus contacts (88), the absorber also preferably contributes significantly to the efficient heating of the HTF fluid within the HTF return passage (211).

The absorbing coating (217) preferably includes absorber coating segments (218) that shadow front-side bus contacts (88), so that such segments of the absorber coating accordingly border preferably rectangular apertures (219) in absorbing coating (217) that allow transmission of solar radiation to the active region of the underlying MJPV (or alternatively other PV). In a preferred alternative embodiment, the apertures are rectangular to accommodate proportionately rectangular long MJPV arrays (e.g. 1 cm by 10 cm) that are cut from wafers, with long axis parallel to the optical axis (73) of the CCC, so as to minimize losses associated with smaller (e.g., 1 cm×1 cm) PV arrays. The absorbing coating preferably comprises a robust broad-band absorber material that is vapor deposited layer of a highly absorbing neutral absorber preferably comprising a black chrome, or alternatively any of various other suitable solar absorbing materials including titanium oxynitride, copper cermets, carbon-filled resin, and other solar absorber coatings of the prior art.

The interior of the inner transparent tube (214) thus comprises a PV module enclosure volume (221) for housing the PV module (85), wherein the enclosure volume is preferably back-filled or circulated with a low thermal conductivity media, such as Argon or a vacuum.

As in previous embodiments, thermal-sinking to the interior supply tube is provided by main bus bars, wherein preferably the plurality of back-plane main bus-bars (91) form continuous thermal contact to the heat-sinking interior tube (123).

A receiver-tube end-cap (224) seals the top end of the receiver tube and also provides an end-cap passage-way (225) that provides passage of HTF between the supply HTF passageway (124), provided by axial supply tube (123), and the return HTF passage-way (211).

While the end-cap of the HTF-shielded MJPV module and associated receiver tube of the present embodiments may be sealed by any of a variety of means well-know to the art, including glass-to-glass seals, glass-to-metal seals, ceramic seals, etc, silicone o-rings (226) are preferred for sealing the top-end of the receiver tube in the present embodiments wherein an HTF temperature of around 250 C or less is preferred in the present embodiment for many solar-thermal applications such as swing-shift refrigeration, water heating, evaporators, etc.

While the CCC/MJPV embodiments herein are ideally embodied for simultaneous production of electricity and heat for various CHP and related applications, these energy forms may be accordingly converted to other forms of energy as an integral function of the CCC apparatus and its associated integral structures. For example, the produce electrical power may be converted to chemical energy in the form of hydrogen or other useful substance of relatively high free energy.

Alternatively, the embodied MJPV insert module may allow to be utilized in conjunction with relatively low-temperature (<300 C) electrically insulating and transparent heat-transfer fluids, such as ethylene glycol or mineral oil, wherein such HTF's are allowed to circulate on both interior and over the exterior surfaces of the MJPV insert assembly (85). Such embodiments may be implemented with additional protective coatings applied to the MJPV modules.

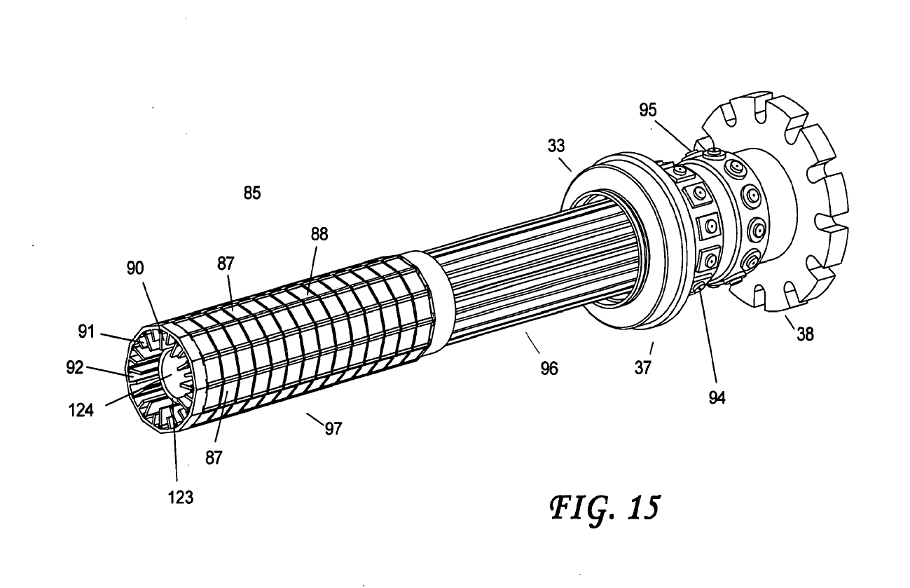

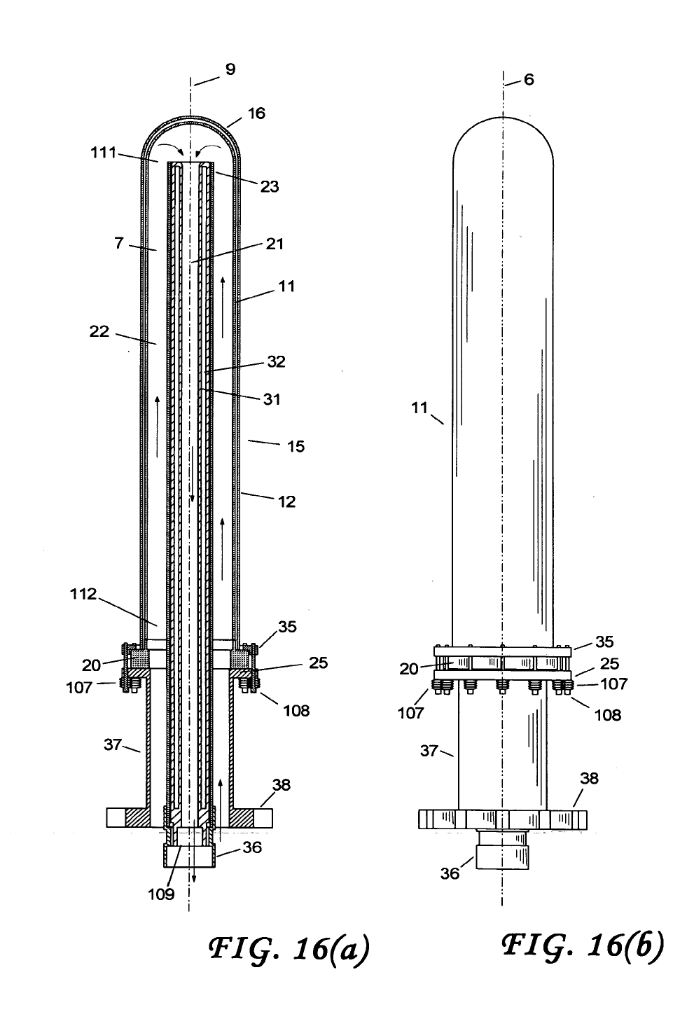

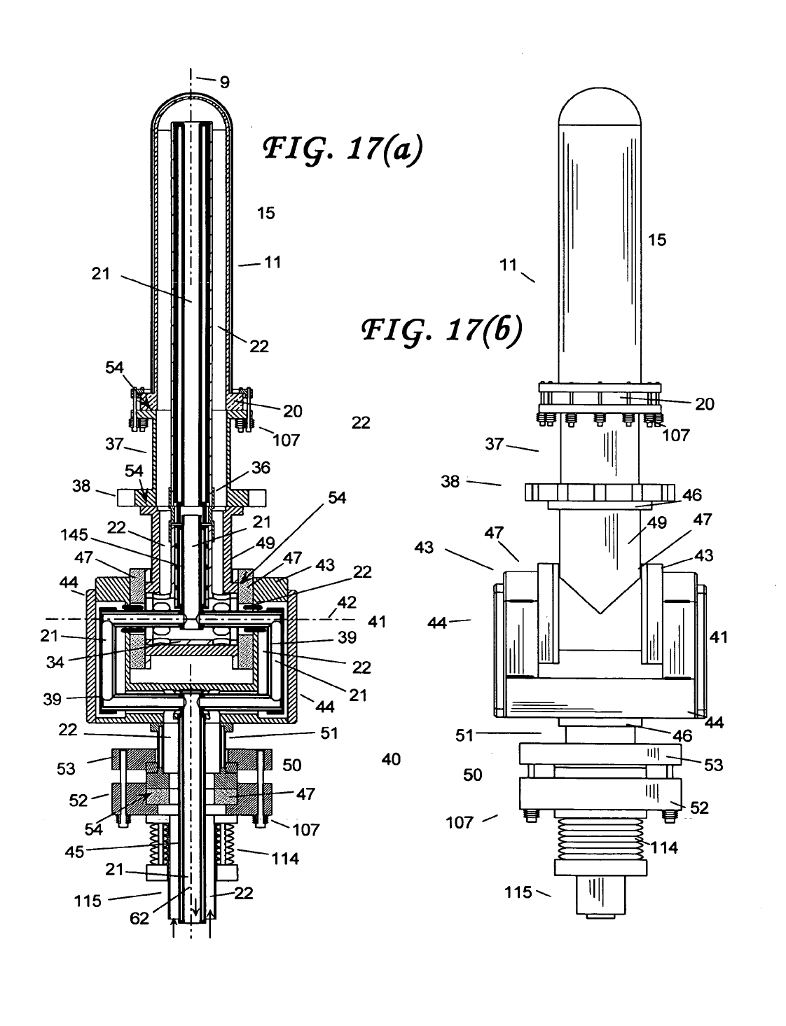

A dual purpose MJPV/solar-thermal receiver tube is accordingly provided, in FIG. 15, wherein the MJPV insert assembly (85) is preferably integrated with the embodied tubulated receiver tube of FIGS. 16-17. In the present alternative embodiments, a central tube (123) provides the HTF coolant supply passage (124) and is preferably comprised of an electrically conductive metal, preferably copper, or alternatively, and aluminum alloy. The central tube (123) is, in the present alternative embodiments, fashioned so as to provide sliding contact with the preferably parallel array of current bus bars that correspond to either positive or negative polarity of the embodied MJPV modules. In the present embodiments, it is preferred that the central tube is fashioned so as to provide sliding and conductive contact comprising sliding insert channels (125) with the MJPV-front-side main bus-bars (90) providing an electrical bus to the front-side contacts of the MJPV modules. The central tube thus provides a mechanical guide surface for maintaining position of the PV insert assembly within the transparent receiver tube. It is preferred that the central tube, thus acting as a guide rail, is machined so as to further incorporate parallel grooves in its outer surface so that the front-side main bus-bars (90) slide along the central tube with the bus-bars guided and contacted by the interior surfaces of these parallel grooves.

It is preferred that electrical interconnection between the main bus bars of the MJPV insert assembly and an external work load powered by embodied MJPV assembly be made by means of high-current electrical bulk-head contacts in the form of preferably two rings (94, 95)—or, collars—that encircle the receiver tube mounting nipple (37), wherein each provide an external electrical contact for one of either the negative or positive polarity of the embodied MJPV assembly. A multitude of high-current metal-ceramic feed-trough's are disposed in each ring in number corresponding to the number of main bus-bars being contacted, wherein contact of each feed-through to its adjacent main bus is preferably by means of sliding, clamp-able rail contacts. High-current copper strapping may then be utilized for carrying current to/from the ring contacts to the desired work-load for the application being powered. The central tube (123) thus is provided connection to the slip-fit interconnect fitting (36) of the previous embodiments so as to provide similar annular and central fluid passages for supply and return of an HTF. Accordingly, the embodied MJPV assembly may be incorporated into an alternative PV-hot-finger assembly, in FIG. 4(a), which may be exchanged with the previously embodied hot-finger assembly in the various CCC/hot-finger embodiments of the present invention.

It will be understood by those skilled in the solar art that the solar concentrator of the preferred embodiments may be utilized in conjunction with a variety of solar energy-conversion devices, such as the previous PV embodiments. In the first preferred embodiment, the energy conversion apparatus, in FIGS. 16-17(a-b), is a single-ended, tubulated solar receiver and integrated 2-axis rotating union, comprising a (a) front-sectional view, and (b) front view, comprising a high-temperature solar-thermal receiver tube.

The previously embodied transparent-receiver-tube embodiments are preferably utilized in a tubulated “hot-finger” configuration comprising a single-ended receiver tube assembly (15), in FIG. 16-17 that is preferably utilized in the embodied CCC In the present disclosure, the term “hot-finger” will be equivalent to the disclosed single-ended receiver tube assembly (15). The term “single-ended” will herein refer to a structural characteristic wherein HTF return and supply connections of the embodied solar-thermal receiver tube are located at one end of the receiver tube, and no other limitations are implied by this term.

A primary advantage of the present embodiment is in providing a solar-thermal receiver tube that can withstand continued temperature cycling between operating temperatures between 600 C to 900 C, and non-operating temperatures that are typically room temperature. For this to be done reliably, it is preferable that the fasteners, metal flanges, and other load-bearing structural elements are substantially removed from the higher-temperature regions of the operating receiver tube assembly. The central absorbing element of the present preferred embodiment is once again a preferably optically absorbing tube (23). Accordingly, the receiver tube assembly of the present embodiments possesses an inner high-temperature region that is preferably the HTF return portion of the receiver tube assembly's fluid circuit. The inner region is preferably insulated from an outer region of the tube assembly by incorporating a multi-walled—double-walled in the preferred embodiment—structure comprising, high-Ni alloy, central insulating enclosure (31) preferably having the aspect of roughly a tube, though any insulated cavity suitable for transporting and insulating the returning HTF may be utilized in the preferred embodiments. The central insulating enclosure is provided with insulating spaces (32) or gaps that separate walls of the double-walled (or triple-walled, quadruple-walled, etc) enclosure that insulate the HTF return passage from the coaxial absorbing tube (23), such enclosures are preferably further insulated by a low-thermal-conductivity gas within the spaces (32) formed within the multi-wall thermal barrier, preferably Argon, which is disposed within the accordingly cylindrical insulating space formed by the preferably tubular double-walled enclosure. Alternatively such thermally insulating space may be provided as a vacuum barrier. It is additionally preferred that the double-walled insulating enclosure have a low-emissivity coating on at least its surfaces that form the insulating space, preferably comprising gold, but alternatively any suitable low-emissivity coating of the prior art. The double-walled enclosure is preferably located along the central axis of the tube assembly, and within the interior of the earlier central absorbing element, so that a central HTF return flow passage (21) is preferably disposed so as to provide a return path for the HTF after having traveled the length of the annular flow space wherein it is preferably heated to its desired high output temperature. Preferably the enclosure is disposed as a tubular element within the central absorbing tube (23), so that the absorbing tube and insulating enclosure may be separately serviceable or replaced.

In the present preferred embodiments, the transparent receiver tube is formed as a monolithic fused silica (or fused quartz) assembly that preferably includes a vacuum layer and outer tube as in previous embodiments. While various high-temperature metal-glass seals and glass-ceramic seals are known and practiced in the prior art (see, for example, well-known texts) is preferred that the transparent receiver tube, outer vacuum tube, and transparent receiver tube mounting flange (20) be constructed from silica, so that no expansion joints are necessary in this monolithic assembly.

Thermal expansion differences between the fused silica mounting flange (20) and the preferably metal alloy connecting flange (25) of the mounting nipple are provided for preferably by means of non-binding surfaces provided on the respective mating surfaces of these two flanges, which, combined with the described optical planarization of these surfaces, allows for these surfaces to slide relative to each other during heating and cooling. This is additionally accomplished by means of the compliant tensioning means (107) that are utilized to provide suitable pressure for clamping together these mating surfaces. Preferably the tensioning means comprise Inconel Belleville washers utilized in conjunction with bolts (108) that hold the two flanges together. Tensioning of the Belleville spring washers is preferably such that the total force holding the two flanges together is equivalent to less than 50 lbs. Such light loading is acceptable in the preferred embodiments, wherein the annular HTF passages are preferably maintained at low pressure of less than 10 psi, and HTF flow is enabled by return side pumping of the fluid. The mating of the fused silica flange to the mounting nipple (37) of the embodied hot-finger assembly is accomplished by means of an alloy clamping ring (35) (preferably with silica glass wool padding) and compliant fasteners comprising a plurality of bolts (108) and compliant tensioning means (107). Alternatively, a glass-to-metal seal may be utilized for conversion of the glass receiver tube to a demountable metal flange assembly.

The mounting nipple connecting flange (25) of the mounting nipple (37) is preferably planarized and polished, similarly to the fused silica flange (20), so that mating of the two flanges will be accordingly provided with sub-micron, preferably less than quarter-micron, clearances between the mating surfaces. The mounting flange of the mounting nipple is preferably coated with an inert low-surface energy material that provides minimum reaction with the salt or fused silica, and further additionally impedes any leakage preferably by virtue of a high wetting angle by the molten salt on the coated material. Alumina is preferred for the coating, though a variety of other coating materials may also provide suitable performance, such as boron nitride, titanium boride, zirconium boride, silicon carbide, or diamond-like carbon coatings.

It is preferred that the fused silica flange and other planar sealing surfaces of the embodiments are planarized and polished to surface RMS <5 micro-inches on its external mating surface, with surface figure preferably better than ¼-lambda at standard HeNe wavelength of 530 nm. The flange is typically on order of ¼″ to ½″ thickness material to provide adequate rigidity.

As in earlier embodiments wherein the preferred HTF of molten salts are being heated by the receiver tube, it is preferred that the inside of the fused silica Receiver tube be coated by a vapor deposition method to provide a diffusion barrier between the silica and the molten salt. Preferred coatings for this purpose are aluminum oxide, chromium oxide, various metal fluorides,

As noted previously, the central absorbing tube can be fashioned or extruded with any suitable cross-section to enhance absorption, so that the external surface need not be circular as in the first preferred embodiments. Accordingly, the profile of the central linear absorption element of the embodied solar thermal receiver tube can be a tube or any other profile, such as a star or polygonal shape. In some alternative embodiments it may include an assembly of rods. Alternatively, the supporting fin-shaped brackets of earlier embodiments may extend the length of the embodied absorbing central tube, so that such fins serve both to position the tube within the mounting nipple (37) as well as to extend into the absorbing section of the receiver tube to enhance solar absorption.

Other rotating unions that provide the tilt and pivot rotations required for two-axis tracking may be utilized without departing from the scope of the present invention. For example, it may be adequate in certain circumstances to utilize a universal rotation union provided in the form of a ball-joint, such as provided by mating concave and convex spherical surfaces, similar to ball-joints of the prior art, made of appropriate refractory materials that may comprise coated high-temperature alloys, glasses, and ceramics.

The various tube coatings of the preferred embodiments are preferably formed prior to fusing of glass parts to form the embodied transparent receiver tube, though, in an alternative embodiment, the inner transparent receiver tube is attached to the fused silica flange prior to coating, and an outer vacuum tube is not incorporated. The fused silica flange is preferably mated to a metal mounting nipple that, as with other metal structural components of the assembly, is composed of a suitable high-temperature alloy, preferably Incolloy, or alternatively Waspalloy, Inconel 625, etc.

In the preferred embodiments, HTF within the annular passage (22) of the receiver tube is heated by solar radiation propagating through the transparent receiver tube as it travels the length of the receiver tube to its sealed end, at which point it returns back by reversing direction in the hemispheric portion (16) of the tube and passing through the central HTF return passage (21). Accordingly, in the preferred embodiments, wherein the HTF is loaded with an absorbing medium, such as a graphite powder or powdered inorganic coatings, the radiatively exposed HTF will have a considerably higher temperature in the bottom region (112) than it will in the top region (111) of the embodied receiver tube's annular passage (22).

In accordance with the present preferred embodiments, the receiver tube assembly, when positioned in the embodied concentrating conical concentrators (CCC's) of the present invention, provide for heating of an HTF to temperatures in excess of 800 C, and is preferably and most effectively employed for heating of HTF's to temperatures in excess of 900 C. This is accomplished preferably by supplying the HTF at suitably liquid temperatures and pressure to the outer annular passage of the receiver tube, so that a processed volume of the HTF travels up the annular passage to the hemi-spherically sealed end (16) of the receiver tube assembly, where it then reverses direction to return though the central insulated passage formed by the insulating enclosure. A slip-fit, absorbing tube interconnect fitting (36) preferably constructed from metal alloy is utilized to join the absorbing tube (23) to vertical tube extension of a perforated retainer sleeve within a preferred adjoining rotating union, or an appropriate connector on an alternative connecting component.

Due to the very high concentrating capabilities (preferably greater than 500 suns) of the embodied CCC (70), it is embodied that the solar flux into the embodied receiver tube will provide for a desired temperature increase of the HTF volume within a relatively short travel distance, relative to thermal receiver tubes of the prior art, so that the embodied receiver tube assembly is quite short (preferably less than 2 meters in length), while enabling a temperature rise of typically 100-450 C within the short travel distance of the HTF volume within the embodied annular passage. Preferably the travel velocity of the HTF is such that a given HTF volume travels the length of the receiver tube in less than a minute, and preferably in less than 0.5 minutes. Accordingly, a high temperature gradient is formed within this length of traveling HTF in the annular passage, so that it is realized and preferred that the embodied receiver tube provides a linear temperature gradient in the heated HTF within the annular passage of ΔT≥100 C per meter, or a temperature difference of greater than 100 Celsius in a meter or less of flow distance.

In combination with the absorbing molten salts (a HTF, or “thermal transfer fluid”) of the high-temperature solar-thermal embodiments, the embodied radial thermal gradients due to low salt thermal conductivity (e.g., typically less than 1 watt/m.K), in earlier embodiments of previous disclosures included herein by reference, and irradiation of the hemispheric end (16) of the hot-finger assembly with top-hat heat-shield, in accordance with the preferred embodiments, in FIG. 1, a solar-thermal receiver tube is realized wherein the heated HTF of the embodied receiver tube is processed to substantially higher temperatures than any emitting surface measured along the linear length of the tube. Conversely, if emissivity of the overall tube is calculated for that of the temperature of the molten salt provided by the receiver tube, the calculated effective average emissivity of the cylindrical receiver tube will result in an effective emissivity of less than 0.05. Since emissivity is by definition an equilibrium measurement, and the present embodiments are by design a highly non-equilibrium device, such emissivity measurements are herein necessarily “effective” quantities.

In this way, the temperature of flanges and fasteners of the receiver tube assembly are maintained at roughly the temperature of the cooler molten salt that is entering the annular passage of the assembly before heating of this salt, whereas the hotter HTF is present at the opposite end of the receiver tube, or else preferably within the insulated enclosure, which preferably sustains less mechanical stress, provides minimal structural bearing functions, and can be encapsulated in an inert gas such as Argon during down-time.

HTF's of the invention may comprise any molten salt including chlorides and fluorides, oil, water, a gas, a super-critical fluid, or any combination of these that is suitable as an effective HTF.

The hot-finger assembly (15), in FIG. 16, comprising the transparent receiver tube (11) and outer vacuum tube (12), inner absorbing element/tube (23), any supporting brackets (24), mounting nipple (37), central insulating enclosure (31) (preferably multi-walled insulated tube), compliant tensioning means (107), and absorbing tube interconnect fitting (36) is preferably incorporated in an assembly that allows pivot and tilt of the receiver tube for two-axis tracking of the sun, preferably wherein the optical axis of the tracked direct sunlight is maintained roughly coincident with the central axis (9) of the embodied receiver tube. Whereas this movement may be provided by alternative rotating unions comprising such solutions as high-temperature, universal ball-joints, it is preferably accomplished by a two-axis rotating union.

The single-ended receiver tube assembly (15) is preferably connected and supported by a 2-axis rotating-union assembly (40), in FIG. 17, which comprises an upper tilt union (41) and a lower pivot union (50). In accordance with the preferred embodiments, the upper tilt union has a horizontal tilt axis (42) for rotational altitude adjustment of the hot-finger in the hot-finger/CCC tracker assembly described later, and the lower pivot union has a vertical pivot axis (62) for rotation of the hot-finger and CCC assembly in the horizontal plane.

The tilt union assembly (41) is housed by tilt union fork (43) providing mechanical function of a tilting axis support similar to that commonly used in telescopes, turret guns, and transits. The tilt union fork supports a rotating portion of the tilt union assembly comprising tilt-union rotating ‘T’ joint (49) resembling essentially a metal alloy ‘T’ pipe fitting with precision formed surfaces, wherein the orthogonal portion of the ‘T’ is connected to the embodied hot-finger assembly by means of an integral sealing flange (46), and the coaxial legs of the ‘T’ provide are coaxial to the tilt axis (42), so that the attached hot-finger assembly (15) is attached to the rotating ‘T’ joint so as to provide a rotation by T joint about the tilt axis. Coaxial supply and return passages for the HTF are accordingly provided along the tilt axis similar to dual-flow rotating unions utilized for lower-temperature applications. In the preferred embodiments

An inner, perforated retainer sleeve ‘T’ assembly (34) comprises a retainer sleeve coaxial to the tilt axis (42) and disposed to provide a coaxial positioning between integral sealing flange (46) and the bushing plates (47). The retainer sleeve incorporates a plurality of hole structures for allowing passage of the supply-side HTF into the region of the tilt axis. Additionally, the retainer sleeve also incorporates an orthogonal tubular element that is maintained coaxial to the orthogonal portion of the tilt union's rotating ‘T’ joint, and provides connection and alignment to the absorbing tube (23) of the hot-finger assembly, via slip-fit absorbing tube interconnect fitting (36). The slip-fit interconnection thus provides a housing and guide for the resistance-fit connection of the exit end of the embodied central insulated return tube (31) of the hot-finger assembly, and a upper pivot-axis insulated tube (145) that provides a return passage for the returning HTF in the rotating ‘T’ joint of the tilt assembly.

Fluid communication between upper pivot-axis insulated-tube (145) and a lower pivot-axis insulated-tube (45) is provided by insulated-tube return ‘C’ insert (39), which is removed and installed by way of removing tilt union side plates (44) that sealingly cover and the internally machined fork housing for the ‘C’ inserts. The insulated C-insert is provided within a similarly C-shaped cavity in the fork, so that the fork houses the C-insert and additionally provides an annular space (22) substantially encompassing the insulated C-insert, so that the embodied annular supply passages and central return passages within the C-insert, are incorporated within the union fork structure (43) for transport of the HTF between the hot-finger assembly and the lower pivot assembly (50).

The rotating tilt union provides fluid passage between the tilted hot-finger assembly and the lower, non-tilting pivot union by means of inorganic rotating seals, comprising precision bushing plates (47), that are disposed coaxial to the tilt axis at either side of the rotating ‘T’ joint (49) and positioned to couple the tilting ‘T’ joint to the non-tilting union fork.

The bushing plates (47) preferably comprise coated disks comprising the same alloy as employed in the fork construction, so that thermal expansion is uniform. The bushing plates are preferably polished and planarized to within optical tolerances, so that parallelism of the bushing plates is within 2 microns, and more preferably within 0.5 microns. Similarly, optical flatness of either planar surface of the plates is such that their resulting polished surface figure is flat to within 0.5 microns. Such polishing methods and tolerances are commonly practiced in the optical and magnetic disk fields, and numerous vendors are available that can provide appropriate fabrication services to produce the embodied bushing plates. It is preferred that the bushing plates are subsequently coated with well-adhering chromium oxide thin film of about 0.25 micron thickness, followed by 100 nm of alumina, so as to act as a diffusion barrier and wear surface in the operation of the rotating unions. Alternative wear surfaces may be utilized, and will depend largely on the chemistry of the preferred molten salt HTF. In the preferred case that the HTF is a chloride salt, or alternatively a fluoride salt, the embodied bushing plate provides suitable corrosion resistance. Likewise, the mating planar surfaces of the ‘T’ joint that form a rotating interface with the bushing plates are preferably fabricated with similar tolerances and coatings. The embodied rotating unions of the first preferred embodiment are operable on the basis of precisely aligned and parallel bushing surfaces that require minimum mechanical loading due to a high precision in their alignment and microscopic clearances that exist between the rotating union surfaces (54) that rotate with respect to one another. Accordingly, non-rotating surfaces of the fork element 43 the bearing disks are mounted to are surfaced for positioning the bushing plates within 2.5 microns of the adjacent rotating surfaces of the ‘T’ joint. It is accordingly preferred that the rotating unions of the present invention are assembled in a clean room environment. Alternative coatings utilized are preferably selected from group comprising boron nitride, graphite, silicon carbide, alumina, borides, nitrides, and fluorides.

absorbing tube interconnect fitting (36) provides a union between the embodied absorbing tube that has preferably an optically absorbing outer surface, and the embodied retainer sleeve ‘T’ assembly (34) of the tilt union assembly. Since this fluid interconnect is preferably coaxial to the outer flow region of the receiver tube, it does not necessarily require a positive seal, so that slip-fit or resistance fit clearance between the interconnect fitting and its respective connecting tube sections is sufficient.

This mounting nipple is preferably constructed from an appropriate metal alloy that is compatible with the operating temperatures of the HTF. In the case that it is a high temperature molten salt, it will be appropriately constructed of Inconel or other appropriate nickel alloy. The mounting nipple may also include an appropriate vacuum or inert gas barrier shielding as is typical in the construction of high-temperature fluid plumbing.

The embodied 2-axis rotating union assembly provides supply and return flow between the solar tracking hot-finger assembly and a stationary HTF connection (115) to a work-load (which workload may comprise a steam turbine, Stirling engine, swing-cycle refrigeration and air-conditioning, materials processing, materials refining, electrolytic processing of materials, etc.) benefiting from the solar heating of the HTF. The 2-axis rotating union thus preferably provides two rotating axes for tilt and pivot of the receiver tube, preferably in unison with the attached CCC structure (70).

The concentrator mount flange (38) of the mounting nipple disposed for connection to the 2-axis rotating union preferably also comprises a mount flange for attachment to the concentrator base, wherein this flange is appropriately larger in diameter so as to provide connection to the cavity base structure (131), in FIGS. 10-11, in the preferred embodiments, or alternatively, base means (118) of the CCC structure (70), in FIG. 2. Since the concentrator mount flange is preferably at elevated temperatures, relative to the concentrator structure, it is preferred that there be a conventional glass fiber gasket installed to impede heat flow between the two elements.

Joints that exist in the preferred embodiments between the insulated tubes are preferably formed as swaged fittings, wherein mating between male and female tapers results in a non-welded resistance-fit. In the case that the union between joined insulating tubes is rotating, since there is no appreciable mechanical load and very minute leakage into the annular supply passage is not problematic, such rotating unions of the HTF-submerged insulating tube can be made by a simple rotating union between machined male-female slip-joints, in FIG. 17.

Whereas it is preferred that the various non-dielectric components be fabricated from corrosion-resistant high-nickel alloys, such a Hastelloy-X, Hastelloy-N, Incolloys, Haynes 230, etc., it may be found advantageous under certain operating conditions to fabricate these parts from pyrolytic graphite instead. In cases that such a relatively brittle material is utilized, or that mechanical loads are relatively high due to weather conditions, receiver scaling, etc., it is then preferred that additional mechanical means are used to reinforce the embodied rotating tilt union. For example, it may be found advantageous to additionally implement supplemental, co-axial rotating joints that fasten to both sides of the embodied tilt union, thereby reinforcing the mechanical rigidity of the specified rotation axis, similar to an orthopedic reinforcement of a human leg, or as is commonly practiced in other areas of the mechanical arts. Such addition of commonly practiced mechanical reinforcement methods and structures, as with additional tensioned cable and strut reinforcements in the larger CCC tracking assembly (120), can be provided in conjunction with the embodied invention as is suited to a specific preferred installation or application.

As is typical with rotating unions and flow pumps of the prior art that are employed for the purpose of manipulating a high-temperature molten salt, additional enclosures for capturing and re-using any leaked molten salt may be implemented in conjunction with the embodied rotating union. Such additional structures as drip pans, “fling” enclosures, heat shields, and additional insulating structures for minimizing thermal losses, may be readily specified by one skilled in the art, and utilized in conjunction with the preferred embodiments, but are not shown herein for the purpose of clearly pointing out the preferred embodiments.

A rotating nipple (51) preferably provides a bottom bushing flange that provides a rotating planarized surface (54) for mating to a bushing plate (47) that is housed in the pivot union's static housing plate (52). Preferably, the entire hot-finger/rotating-union assembly is encompassed by an IR-reflective shield during actual operation.

Beneath the rotating tilt union of the two-axis rotating union is a rotating pivot union (50) that provides means for rotation of the single-ended receiver tube assembly about the pivot axis (62), thereby allowing the hot-finger and rotating tilt union (41) to pivot with the CCC structure while simultaneously the HTF fluid is transferred between the rotating single-ended receiver tube assembly and the static work load connected through the pedestal at work-load connector (115).

The lower pivot union (50) incorporates the rotating nipple (51) that is coaxial to the pivot axis (62) and is attached to bottom surface of the tilt union fork by means of an integral sealing flange (46). As similarly embodied in the tilt union assembly, the manifolding of the rotating pivot union provides a central lower insulated tube (145) and an annular HTF supply passage (22) peripheral and surrounding this lower insulated tube. The high temperature rotating unions of the present invention differ from such prior art rotating unions in that preferably no organic materials are used in sealing, and leak-tight seals are obtained instead by the mating of optically figured planarized surfaces so as to form very parallel and precise interfaces (54) terminated with high-temperature tribological coatings similar to the bushing plates of the tilt union.

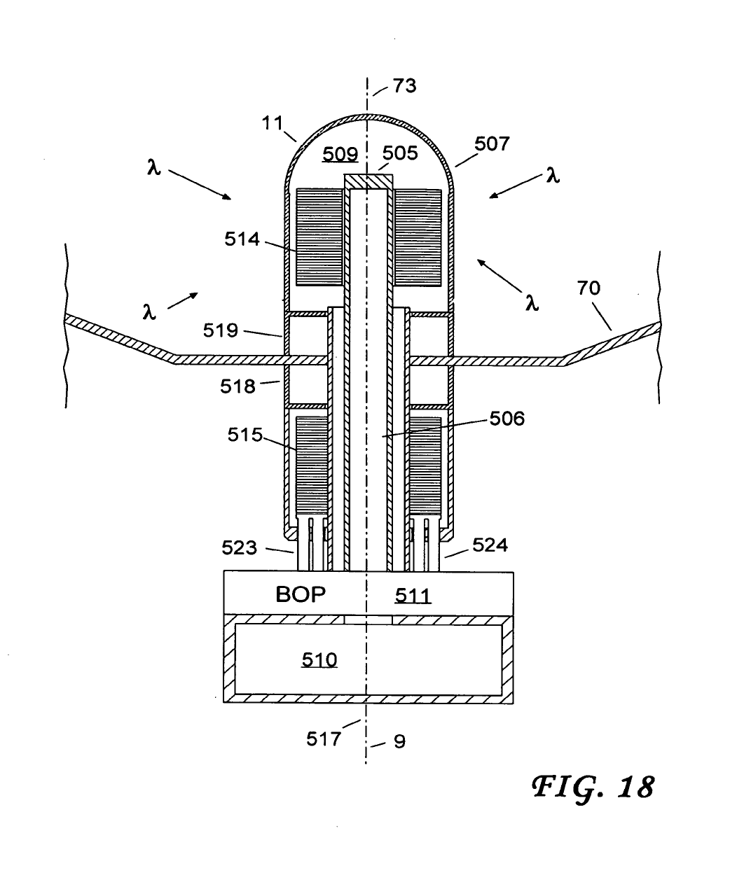

As previously embodied, in FIGS. 1-17, in conjunction with embodiments having a CCC/receiver-tube combination for heating a molten salt HTF, oil, or alternatively a photovoltaic array, the inventive CCC/receiver tube combination can be utilized in conjunction with a variety of energy conversion processes. In an alternative embodiment, the disclosed solar concentrator is implemented for providing solar-thermal energy to fuel cells and electrolyzers for accordingly providing thermal energy for their various endothermic processes, such as hydrogen generation/reformation. In the present embodiments, in FIG. 18, an alternative application utilizing the CCC (70) in conjunction with an electrolyzer (514) and/or fuel cell (515) is embodied, wherein direct irradiation of a catalytic hydrogen generation apparatus is ideally provided by the inventive CCC, and wherein preferably the hydrogen generation apparatus is a solid-oxide electrolyzer that accordingly conducts oxygen ions through a solid oxide electrolyte so that preferably a hydrogen-bearing gas flowing through the apparatus and exposed to the reducing side of the electrolyzer cell is enriched in its molar hydrogen content, or alternatively in its Gibb's free energy, whereas a gas on the opposite (oxidizing) side of the electrolyte in the electrolyzer cell is normally enriched in its oxygen content, as is normally obtained in conjunction with such devices. In the present embodiment, direct irradiation of the electrolyzer is preferably provided so that solar radiation is incident on the reducing catalytic electrode of the electrolyzer so that the embodied catalytic hydrogen-generating apparatus is preferably a photocatalytic apparatus, and so that, accordingly, photo-absorption processes are beneficial and preferred for enabling generation of a desired chemical product in the embodied electrolyzer, namely an oxidizable fuel.

Integration of high temperature fuel cells and solid oxide electrolyzers with a CCC-based solar-thermal energy source is previously disclosed by same applicant in co-pending U.S. patent application Ser. No. 12/803,213 (Hilliard) and in PCT application PCT/US2010/002178 (Hilliard), which are included herein by reference in their entirety. It is further disclosed in these previous applications by applicant that an annular high-temperature fuel cell apparatus, preferably SOFC, is integrated to the CCC so as to benefit from either direct heating or from a hydrogen generation means powered by the CCC. Accordingly, solar-thermal generated heat from the CCC may be used directly or indirectly for providing thermal energy required for any of a variety of hydrogen-forming or reducing processes.

In the previous patent applications of same applicant, an annular, solid-oxide electrolyte based apparatus is disclosed for electrolyzing applications such as oxygen/hydrogen separation, “syngas” processing (i.e., hydrogen and carbon monoxide), coal gasification, and other methods of increasing hydrogen content or otherwise increasing the available free energy of a resultant hydrogen-bearing gas over that of a precursor gas, wherein this electrolyzer is mounted in the focusing region of a solar concentrator, most preferably a CCC. This combination is again pointed out in the present embodiment, further utilizing, in particular, a CCC constructed in accordance with the preferred embodiments herein, preferably utilizing high-N CCC's formed from individually constructed frustums, and, more particularly, in accordance with subsequently embodied tetrahedra-reinforced frustums, in FIGS. 4-13.

As disclosed in the previous applications and embodied herein, in FIG. 18, multi-frustum solar concentrators may be utilized in conjunction with hydrogen electrolyzer/formation means and fuel cells of the prior art in integral packages wherein a fuel cell (515) is mounted below the frustum base, preferably in combination with a storage tank (510) for storing an energy-storing medium, preferably as either chemical-energy or thermal-energy, and more preferably as a hydrogen-containing gas.

Accordingly, solid-oxide electrolyzers of the prior art and herein may be identified as either hydrogen generators (or reformers) or oxygen generations systems (OGS), by virtue of the according oxygen-ion conduction provided in all such devices, wherein specific input gases and specific electrode compositions of the solid oxide electrolyzer may be more specifically disposed for a particular desired gas-generating application. The integral assembly of electrodes and electrolyte, and, in the preferred embodiments, also a supporting metallic grid, is frequently referred to as a membrane/electrode assembly (MEA) in the prior art, or monolithic electrolyte assembly. In the present embodiment, such electrolyzers having solid oxide MEA's are preferably illuminated on the hydrogen-rich (reducing) side of the MEA, and this is preferably accomplished by allowing solar radiation to enter from the peripheral edges of each MEA in the preferred annular electrolyzer stack, wherein openings typically utilized for the circulating gas are additionally utilized as according optical apertures for entrance of the solar radiation, as further detailed in the cited co-pending applications. Since the electrolyzer is preferably operated by conduction of an ionic current through the electrolyte, it is thus appropriate to identify the embodied electrolyzer as additionally a photo-electro-catalytic hydrogen generator, wherein photochemical activity may be provided by photoabsorption at the embodied titania-metal composite electrode for photocatalysis associated with what is described as semiconductor surface interaction, or alternatively provided by any other photo-absorption process known to enable chemistry, such as pertaining to photoelectron emission, irradiation of low-work function insulator surfaces, direct photo-absorption by reactive species, quantum tunneling, quantum well resonance, quantum dots, etc. Accordingly, in a CCC/receiver tube arrangement that is an alternative to the present embodiment, the embodied photoelectrocatalytic generator may comprise instead a plurality of Gratzel cells utilizing titania nanotubes, or other such relatively low-temperature electrolyzing cells that utilize the electrolyzing properties of a semiconductor/liquid or semiconductor/vapor surface, with or without photo-absorbing dyes/solutes, that is incorporated in an electronic circuit by communication with adjacent electrodes.

In particular, in the present embodiment, the embodied CCC is utilized to irradiate a centrally disposed, annular, solid oxide electrolyzing stack (514), so that the annular electrolyzing (gas generating) stack is accordingly irradiated and heated by the solar concentrator for separating and accordingly forming hydrogen-rich and oxygen-rich gases and/or vapors at opposing porous electrodes of the MEA. There is accordingly utilized a central support tube (505) preferably disposed for containing return flow of oxygen from oxygen emitting side of the solid oxide gas separation device (514) with oxygen return passage (506) for oxygen-rich gas produced from the solid oxide gas separation device (514). A transparent enclosure (507) encloses the annular gas-separation stack for containing the hydrogen-rich gases, preferably comprising a supply passage to the stack, the enclosure preferably comprising a hemi-spherically-terminated glass tube composed of preferably a borosilicate or more preferably a fused silica glass tube terminated on top with a hemispherical end. Accordingly, the solid oxide gas separation device is disposed concentrically in the glass enclosure space (509) formed by the transparent enclosure further disposed for containing water-vapor or other oxygen-bearing vapor/gas for delivery to the oxygen-adsorbing electrodes of the solid oxide electrolyzer, whereby hydrogen gas is preferably assisted in its dissociation at the electrode surfaces by catalysis, and more particularly photocatalysis, rendering the gas circuit of the glass enclosure space hydrogen rich. Such annular solid oxide stacks in fluid communication with an outer enclosure space are taught in the prior art, such as the electrolyzer stack taught in U.S. patent application Ser. No. 10/411,938 (particularly in association with FIG. 9 of that application). The transparent enclosure for transmitting solar radiation therein is preferably supported by a concentric stack mounting structure (519) insulating the glass enclosure thermally from the concentric CCC. Similar fuel cell mounting means (518) are provided for insulating the high-temperature fuel cell (515) from the concentrator as well.

Porous electrode compositions utilized as catalyzing electrodes in the present SOFC embodiments may be any of those utilized in such solid oxide devices of the prior art, but preferably are based on perovskite materials selected from group containing manganates, lanthanates, titanates, zirconates, and tantalates for the cathode side, and nickel compositions on the anode side. In the case of the embodied electrolyzer, electrodes incorporate combinations of titania/platinum, titania/silver, and titanium/nickel. Alternatively, any other appropriate materials of the prior art may be incorporated in the various porous electrode compositions, electrolytes, and interconnects of the embodied, both SOFC and electrolyzer, solid oxide electrolytic stacks.

In particular, the oxygen-adsorbing and hydrogen-rich (reducing side) electrode of the centrally-disposed oxygen/hydrogen generation electrolyzer stack (514) is accordingly formed as a porous electrode that incorporates photo-catalytic compositions, preferably a platinum-TiO₂ composition that efficiently dissociates water into hydrogen gas and oxygen ions, typically in conjunction with a hydrocarbon and/or carbon dioxide, such that the oxygen ions subsequently conduct through the solid oxide membrane, or alternatively compositions including LSM or any appropriate photocatalytic electrode composition found suitable in the art of solid-oxide-based photocatalysis. Alternatively, the annular electrolyzer component (514) of the present embodiments may comprise a tubular MEA as taught in the tubular fuel cell and electrolyzer art.

Fuel cell apparatus and CHP systems that combine a solid oxide fuel cell apparatus with an external electrolyzer or other external reformer are numerous and well-developed in the prior art. Accordingly, the associated plumbing and circuitry interconnecting these systems are incorporated in the “balance-of-plant” (511) portion of this combination.

In the present embodiment, a preferably annular solid oxide electrolyzer, with central axis (517), is irradiated with solar radiation X from the concentrically positioned CCC, wherein the gas separation device is accordingly heated to high temperatures (typically greater than 600 C) suitable for efficient generation of a hydrogen-rich gas, which gas is stored in an integral storage tank (510) for usage by a coaxially mounted, annular solid oxide fuel cell. It is preferred that the oxide electrolyte layer be implemented with sub-micrometer—and preferably less than 500 nanometers—thickness, so that the sampling rate of oxygen vacancies to a specific area of an adjacent, porous, catalytic electrode, can be much higher than that allowed by thicker electrolyte layers. Such reduced-thickness, thin film electrolytes seen herein as essential if the sampling rate of the oxygen vacancies at the electrolyte/catalytic electrode interface is to not be a limiting rate in the ability of the catalyst to execute the preferred reaction steps that lead to an oxygen ion being transported through the solid oxide electrolyte of the irradiated electrolyzer. Likewise, and in accordance with cited earlier disclosures by applicant, the SOFC of the present embodiment preferably utilizes similarly dimensioned, thin film, solid oxide electrolytes, as well.

It is further preferred that the oxygen-rich side of the MEA's of the electrolyzer stack are accessed through a central support tube (505). Movement of oxygen-rich gas from the oxygen rich-side of the MEA is provided at least in part by the oxygen-ion conduction of the solid oxide electrolyte accordingly providing a positive pressure on the oxygen-rich side of the MEA, and wherein this electrolytically transported oxygen is preferably provided through the inner sealing region to the oxygen return passage (506). Accordingly propagation of solar radiation preferably enters the disk-shaped flow spaces interleaving MEA's of the electrolyzer stack, these disposed for a supplied water vapor/carbon-bearing gas interleaving the embodied MEA's of the embodied annular stack.

A storage tank (510) is preferably mounted integrally to the presently embodied assembly, preferably integral to a balance-of-plant (BOP) assembly (511) integrally mounted to the embodied assembly for providing fuel (preferably hydrogen) to the solid oxide fuel cell mounted below the solar concentrator. The BOP assembly is constructed in accordance with the gas flow, compositional control, temperature-control, and cut-off mechanisms commonly incorporated in the known art of solid oxide fuel cells, such BOP means preferably controlling hydrogen fuel pressures and flows to and from the hydrogen storage tank, and preferably supplying appropriate hydrogen rich gases and exhaust control for the preferred annular solid oxide fuel cell (515), also having central axis (517), by means of SOFC air-side gas interconnection (523) and SOFC fuel-side gas interconnection (524). In the preferred embodiment wherein a storage tank is utilized for hydrogen storage, there may be accordingly be incorporated in the storage tank various hydrogen adsorption/desorption media including carbon. The solid oxide fuel cell (515), preferably is an annular solid oxide fuel cell in accordance with previous disclosures by author cited herein, and is disposed concentric to the central axis of the solar concentrator, so that the optical axis (73) and central axis (517) of the annular solid oxide embodiments are, preferably, substantially coincident. Hydrogen that is stored in the hydrogen storage tank is then available for powering the fuel cell stack, which can accordingly produce electrical power based on the load requirements.

As is disclosed in previous cited patent applications by same author, the receiver tube, with associated fluid circuits and storage tanks, can be integral to the CCC structure, so that, accordingly, no rotational or pivot unions are required. As will be appreciated by one skilled in the art, such integrated configurations incorporating integral storage tanks and fluid circuits may be utilized in conjunction with any of the variety of energy transporting fluids and gases utilized in the CHP art, such as the various embodied solar-thermal fluids and gases, precursor gases, or any gases used in conjunction with the previously disclosed solid oxide system including syngas, methane, butane, oxygen, natural gas, etc. Accordingly, various other storage volumes may also be integrated as needed for a specific application.

It will be appreciated by those skilled in the art that, whereas the catalytic hydrogen generating means of the present preferred embodiment is particularly embodied for the purposes of pointing out the invention, any hydrogen-generating means of the prior art that is known to require a heat source may be readily combined with the CCC reflector embodied herein, whether such hydrogen-forming apparatus is disposed for fueling a fuel cell, as in the present embodiments, or is utilized for storing a fuel for other purposes such as distributed generation for hydrogen-driven automobile fueling.

While the CCC structure of the preferred embodiments, and the various associated energy conversion apparatus embodied, in FIGS. 1-18 and other alternative embodiments included herein by reference, are provided so as to teach the various novel structures and operating principles set forth, it is not intended that the inventive matter set forth herein be limited to those particular embodiments, and it will be appreciated by those skilled in the art that many further embodiments may be readily envisioned without departing from the scope and spirit of the inventive matter set forth herein. In particular, whereas each of the various embodiments in FIGS. 1-18 are directed to the invention in a particular aspect or preferred application, it will be readily appreciated by those skilled in the art that various features of the multiple embodiments set forth herein may be readily combined with one another as may suite a specific set of circumstances.

Accordingly, and in light of the various prior art energy storage, conversion, and generation processes and apparatus that are regularly incorporated in energy-conversion and combined-heat-and-power (CHP) systems of the prior art, it will be readily understood by those of normal skill in the art that a vast number of variations and combinations utilizing such known components and processes in combination with the disclosed embodiments may be readily envisioned by those of normal skill in the art.

Accordingly, flow-chart “engineering” of some specific combination of well-known structures and processes of the prior art of CHP systems that is merely combining such known processes and apparatus of the prior art so as to interact according to demonstrated and well-known principles is readily performed by those of normal skill in the art, and therefore such combination of the disclosed solar-thermal embodiments as a heat source in such prior-art combinations that are known to benefit from a heat source is readily anticipated by and within the scope of the disclosed solar-thermal apparatus. For example, a wide array of solar-thermal and solar-electrochemical receiver tubes and apparatus may be utilized in conjunction with the disclosed CCC, such as, for example, various solar apparatus for use with solar concentrators that are reviewed in “Solar Fuels and Materials” by Aldo Steinfeld and Anton Meier (copyright 2004) which is included herein by reference.

In particular, use of the disclosed solar-thermal embodiments in any energy conversion or energy generation process that is known to benefit, or may be readily seen to benefit, from a supplemental, auxiliary, or primary heat source would be obvious to those of normal skill in the art, and would therefore be anticipated by the disclosed preferred embodiments.

It will be further appreciated that the present embodiments may be readily integrated with or modified to include, by those of normal skill in the art, various mechanical structures, support members, feed-throughs, heat exchangers, compliant members, fasteners, bellows, and other commonly combined mechanical means utilized in solar-thermal and solar-thermal CHP, so as to provide well-known advantages in various specific applications. It will accordingly be further appreciated that the disclosed solar-thermal embodiments may also be readily integrated by those skilled in the art with one or more of these prior art components so as to be structurally “integral”, “modular”, “monolithic”, or “portable” without departing substantially from the scope or spirit of the invention.

As previously embodied, the preferred embodiments are readily combined with broadly established apparatus and processes for transferring or storing energy, including those means comprising thermal energy, chemical energy, optical energy, electromagnetic energy, or mechanical energy. Such means for transferring and storing energy will generally include or be enabled by energy sources including wind, solar, hydroelectric, nuclear, coal, natural gas, oil, and various other hydrocarbons and fossil fuels.

Accordingly, the embodied concentrator and related solar-thermal embodiments are not intended to be limited to any particular work-load or end-use. As will be readily appreciated by those skilled in the art, the disclosed embodiments may be readily adapted for use in such energy uses as transportation, including marine and land-based, building heating and cooling, industrial processing including refining, chemical processing, mining, water desalinization, as well as any other application known to benefit from cost-effective solar-thermal or solar-electric power generation.

In addition, it will be readily understood by those skilled in the art that processes and apparatus for electrical power generation whether localized, power-plant, on-site CHP, distributed-generation, portable, modular, integrated, roof-top, auxiliary power units (APU) including marine-based or other transportation-based APU's, or any other such mode of utilizing electrical power generation apparatus and processes may be readily combined and variously integrated by those skilled in the art with the solar embodiments herein without departing from the intended scope and applications.

Similarly, and in accordance with the preferred embodiments, the disclosed solar-thermal and CHP embodiments may be readily utilized to provide thermal energy for conversion to chemical energy by combination with any known chemical energy conversion processes and apparatus of the prior art, including such applications as materials processing and refinement, gas and liquid processing and refinement, fuel conversion processes, methane conversion, hydrocarbon conversion, electrolytic processes, gas-shift reactions, gas reformation, steam conversions and reformation, external reformation, fuel-cell warm-up means, balance-of-plant (BOP) processes, gasification including coal gasification processes, and any other well-known thermo-chemical and thermo-materials conversion processes and apparatus, wherein such processes and apparatus are already known to benefit from combination with a cost-effective heat source; such processes and apparatus are readily combined with the disclosed solar-thermal embodiments in accordance with principles well-understood by those skilled in the art of these respective thermodynamic processes, and accordingly are not outside the scope of the disclosed inventive matter.

Thus, in accordance with these well-known and understood applications of the prior art, the disclosed solar apparatus may accordingly be combined by those of normal skill in the art with known components common to such well-known energy conversion cycles, processes, and apparatus, particularly those proposed and/or used for power generation and combined heat and power (CHP) systems. Such components include but are not limited to, gas or steam turbines, hydrogen generation means including thermo-chemical, electrolytic and photo-catalytic hydrogen generation means, nuclear reactors, Stirling engines, internal combustion engines, solar PV panels, any fuel cells including proton-exchange membrane fuel cells (PEMFC), direct-methanol fuel cells, solid oxide fuel cells, molten carbonate fuel cells, any storage device including batteries, fuel cells, and any appropriate tank or storage volume for a thermal-energy or chemical-energy storage medium, swing-cycle cooling apparatus and refrigeration cycle components, various absorbent beds and thermally-cycled desiccants volumes, heat exchangers, and any other such related components that could benefit by combination with a supplemental or primary heat generating source, and accordingly such prior art CHP components can be combined with the disclosed solar apparatus without departing from the intended scope and spirit of the disclosed invention.

Inventive matter of this specification and drawings was disclosed to SolarSiliconUSA, represented by Andy Hilgers of Los Angeles, Calif., USA, and Dick Bos, (also of GET IT Co ltd, Thailand) under a formally executed non-disclosure agreement (Jan. 8, 2010).

It is not intended that the core material of the disclosed hollow-core frustums be limited to media of the preferred embodiments, as any appropriate material may be substituted by those skilled in the art. The preferred core material provides adequate rigidity, strength, and lightness of a structured framework, such that the core is predominantly open space; accordingly, any core material having such embodied properties may be utilized, including core materials with either ordered or disordered structures. Open spaces of the core material may be on the order of thickness of the embodied frustum structures, or may be much smaller or even microscopic. In the preferred embodiment where the core material includes a corrugated thin sheet metal, such corrugation may exist in any suitable aspect, orientation, or format. for example, in the alternative preferred embodiment of a wound preform, such preform may be constructed core layers comprising a single corrugated sheet.

It is also not intended that there be any restriction on scaling of the inventive CCC structure, since it may readily be fabricated in smaller or larger sizes than those contemplated herein. For example, miniature versions of the inventive CCC structure and manufacturing means may be implemented for construction of solar panels incorporating a plurality of such concentrators in a periodic array for irradiating a corresponding number of individual receiver modules in accordance with the preferred embodiments.

It is also not intended that the disclosed solar concentrator be limited in its application in any way, as any means for collecting solar energy may be ly benefit from appropriate combination with the embodied concentrator. Such means for collecting and/or transferring solar-generated energy may include but are not limited to any heat transfer fluid, gas or vapor, expanding medium in a closed circuit heat pipe, etc; also any means of providing any form of electromotive force whether by photovoltaics, thermoelectric, electrolyte, or other. Similarly any form of storing chemical energy may be incorporated, whether by electrolysis, phase-change mediums, heat storage fluids, chemical energy storage, etc.

Like parts correspond to like parts in different embodiments; for example, the centerline (9) representing the central axis of the embodied tubular symmetry is to be regarded as such major axis with respect to the specific embodiments in which it is pointed out.

Reference throughout this specification to “one embodiment” or “an embodiment” means that a particular feature, structure, process, block, or characteristic described in connection with the embodiment is included in at least one embodiment of the present invention. Thus, the appearances of the phrases “in the present embodiment” or “in another embodiment” in various places throughout this specification are not necessarily all referring to the same embodiment. Furthermore, the particular features, structures, or characteristics may be combined in any suitable manner in one or more embodiments.

Although the present invention has been described in detail with reference to the embodiments shown in the drawing, it is not intended that the invention be restricted to such embodiments. It will be apparent to one practiced in the art that various departures from the foregoing description and drawings may be made without departure from the scope or spirit of the invention.

What is claimed is:

1. A solar receiver tube, comprising:
a.) an enclosure substantially transparent to solar radiation, the enclosure having a first end defining an opening, the enclosure having a sealable end opposite the first end;
b.) a first passageway disposed within the enclosure;
c.) a second passageway disposed within the enclosure, the second passageway in fluid communication with the first passageway;
d.) a plurality of multi junction photovoltaic elements, the photovoltaic elements disposed within the enclosure;
e.) a mounting structure within the enclosure, the photovoltaic array mounted onto the mounting structure, the first passageway disposed within the mounting structure, so that the first passage way is in thermal communication with the photovoltaic array; and,
f.) a demounting structure disposed at the open end, the demounting structure disposed to provide fluid interconnections and electronic interconnections.

2. A process for operating a concentrated solar collector, including the steps:
a.) providing a solar receiver structure, the structure defining a passageway, the structure including a photovoltaic array comprising at least two semiconductor junctions having separate response bands;
b.) passing the heat-transfer fluid through the structure, so that the fluid flows through the passageway, the heat transfer fluid possessing a spectral absorption feature in the response band of a junction; and,
c.) irradiating the structure with solar radiation, the solar radiation irradiating the heat-transfer fluid in the passageway so that a first portion of the radiation is absorbed by the heat-transfer fluid, wherein a second portion of the radiation transmits through the heat-transfer fluid in the passageway so as to be incident on the photovoltaic array, thereby producing an electric current, the spectral feature adapted to actively balance radiant flux to the junctions.

3. A process for operating a solar collector, including the steps:
a.) providing a solar receiver structure, the structure defining a first volume, the first volume, the structure defining a second volume, the second volume in fluid communication with the first volume, the structure including a multitude of multi-junction photovoltaic elements;
b.) passing a heat-transfer fluid through the structure, so that the fluid passes through the first volume before passing through the second volume, wherein the fluid removes heat from the photovoltaic elements in the first volume; and,
c.) irradiating the structure with solar radiation, such that the solar radiation irradiates the heat-transfer fluid in the second volume wherein a first spectral portion of the radiation is absorbed by the heat-transfer fluid, the first spectral part predominantly comprising energy of infrared spectral regions, a second spectral part of the radiation including visible spectral regions absorbed preferentially by the photovoltaic elements, thereby producing an electric current.
